(19) United States
(12) Patent Application Publication
(10) Pub. No.: US 2026/0343386 A1
(43) Pub. Date: Oct. 29, 2026

(54) METHOD OF FIRST COMMUNICATION APPARATUS AND FIRST COMMUNICATION APPARATUS

(71) Applicant: NEC Corporation, Minato-ku, Tokyo (JP)

(72) Inventors: Toshiyuki TAMURA, Ibaraki (JP); Iskren IANEV, Reading (GB); Kundan TIWARI, Bengaluru (IN)

(73) Assignee: NEC Corporation, Minato-ku, Tokyo (JP)

(21) Appl. No.: 19/115,385

(22) PCT Filed: Sep. 22, 2023
(86) PCT No.: PCT/JP2023/034456

§ 371 Date: Mar. 26, 2025

(30) Foreign Application Priority Data
Sep. 28, 2022 (IN) 202211055756

(51) Int. Cl. H04W 48/16; H04W 48/20

(52) U.S. Cl. CPC H04W 48/16; H04W 48/20

(57) ABSTRACT

An aspect of this disclosure includes a method of a first communication. The method includes communicating with a second communication apparatus. The method includes sending Target Network Slice Selection Assistance Information (NSSAI) for a list of a Tracking Area (TA).

### TECHNICAL FIELD

The present disclosure relates to a method of a first communication apparatus, and a first communication apparatus.

### BACKGROUND ART

In 3GPP Rel-17, the 3 GPP SA2 group introduced the bellow Target NSSAI functionality in NPL 1.

### 5.3.4.3.3 Redirection to Dedicated Frequency Band(s) for an S-NSSAI

If a Network Slice, S-NSSAI, is configured to be available only in TAs covering specific dedicated frequency band(s), then there may be a need to redirect the UE to the dedicated frequency band(s) when such S-NSSAI is requested. If the Requested NSSAI contains S-NSSAI(s) that are not available in the UE's current TA, see clause 5.15.8, the AMF itself or by interacting with the NSSF as described in clause 5.15.5.2.1 may determine a Target NSSAI to be used by the NG-RAN, in addition to the information the AMF receives, such as the Allowed NSSAI and the RFSP for the Allowed NSSAI, to attempt to redirect the UE to a cell and TA in another frequency band and TA that supports the S-NSSAIs in the Target NSSAI. The Target NSSAI includes at least one S-NSSAI from the Requested NSSAI not available in the current TA, but available in another TA in different frequency band possibly overlapping with the current TA, and optionally additional S-NSSAIs from the Requested NSSAI that are configured to be available within the same TAs as the S-NSSAIs not available in the current TA. If the serving PLMN supports the subscription-based restrictions to simultaneous registration of network slices (see clause 5.15.12), and if the UE has NSSRG as part of the subscription information received from the HPLMN, the Target NSSAI includes only S-NSSAIs sharing at least one NSSRG.

The Target NSSAI may be excluding some of the Allowed NSSAIs and include some of the rejected S-NSSAIs due to lack of support in the TA where the UE is located based on network policies that are in line with customer and operator agreements. The Target NSSAI shall only include S-NSSAIs that can be provided in an Allowed NSSAI for the UE. The Target NSSAI may include e.g.:
all or a subset of the Rejected S-NSSAIs for RA when none of the S-NSSAIs in the Requested S-NSSAI were available in the TA where the UE is;
all the S-NSSAIs of the Allowed NSSAI and all or a subset of the Rejected S-NSSAIs for the RA;
a subset of the S-NSSAIs in the Allowed NSSAI and all or a subset of the Rejected S-NSSAIs for the RA if the operator policy is to prefer this Target S-NSSAI to the Allowed NSSAI.

The AMF should retrieve an RFSP Index suitable for the Target NSSAI and includes the RFSP Index in the information sent to the NG-RAN. The AMF retrieves the RFSP Index from the PCF or, in case PCF is not deployed the AMF determines the RFSP Index according to local configuration. The RFSP index associated to the Target NSSAI is considered if the RAN succeeds to redirect the UE to a new TA outside the RA, otherwise the RFSP index of the Allowed NSSAI is considered.

If the Requested NSSAI contains S-NSSAI(s) which map to S-NSSAI(s) of the HPLMN subject to Network Slice-Specific Authentication and Authorization that are not available in the UE's current TA, the AMF shall proceed with the Network Slice-Specific Authentication and Authorization procedure as described in clause 4.2.9 of NPL 2. If the AMF determines a new Allowed NSSAI at the end of Network Slice-Specific Authentication and Authorization steps and some S-NSSAI is not available in the UE's current TA, a Target NSSAI and corresponding RFSP index may be determined and provided to NG-RAN during UE Configuration Update procedure as described in clause 4.2.4.2 of NPL 2.

The NG-RAN shall attempt to find cells of TAs that can support all the S-NSSAIs in the Target S-NSSAIs, and if no such cell of a TA is available the RAN can attempt to select cells of TAs that best match the Target S-NSSAI. The NG-RAN shall attempt to ensure continuity of the PDU Sessions with activated User Plane associated with the S-NSSAIs in the Allowed NSSAI which are in the Target NSSAI. Also, the NG-RAN should attempt to ensure continuity of service for the S-NSSAIs of the Allowed NSSAI also available in the Target NSSAI, before prioritizing cells that are not supporting one or more of the S-NSSAI of the Allowed NSSAI also available in the Target NSSAI.

The NG-RAN attempts to determine target cell(s) supporting the Target NSSAI considering the UE Radio Capabilities (i.e. the AMF (if available in the UE context) shall provide the NG-RAN with the current UE Radio Capability Information or the RACS UE Radio Capability ID when a Target NSSAI is provided, if the NG-RAN had not yet received any of them, or, if the AMF cannot provide any of these, the UE Radio Capability Information may be retrieved by the NG-RAN from the UE).

Once the target cells are determined, the NG-RAN initiates RRC redirection procedure towards the target cells, or the NG-RAN initiates handover for the UE with active PDU Sessions associated with the S-NSSAIs which are in the Target NSSAI, if possible.

After a successful redirection or handover of the UE to a new TA outside the current RA, the UE shall perform a Mobility Registration Update procedure and the S-NSSAIs the new TA supports can be allowed if the UE requests them. In order to ensure that the UE is redirected to a TA outside the current RA, thus triggering a Mobility Registration Update procedure enabling the UE to request the S-NSSAI(s) that were rejected for the RA, the AMF shall set the RA so that the RA does not include TAs supporting the S-NSSAIs rejected for the RA included in the Target NSSAI when the AMF provides a Target NSSAI to the RAN.

### CITATION LIST

### Non Patent Literature

NPL 1:3GPP TS 23.501: System architecture for the 5G System (5GS). V17.5.0 (2022-06)
NPL 2:3GPP TS 23.502: Procedures for the 5G System (5GS). V17.5.0 (2022-06)
NPL 3:3GPP TS 38.413: NG Application Protocol (NGAP). V17.1.1(2022 -06)
NPL 4:3GPP TR 21.905: Vocabulary for 3GPP Specifications. V17.1.0 (2021-12)
NPL 5:3GPP TS 23.503: Policy and Charging Control Framework for the 5G System. V17.5.0 (2022-06)

### SUMMARY OF INVENTION

### Technical Problem

While the already Rel-17 agreed Target NSSAI functionality assists steering the UE to a cell in a TA operated in different frequency band where the S-NSSAI(s) from the Target NSSAI are supported, this mechanism of steering the UE is provided via RRC connection redirection or Handover while the UE is in connected mode (e.g., in RRC connected mode or in RRC connected state) with established PDU Sessions. However, there are some unclear or problematic situations regarding the Target NSSAI in 3GPP specifications.

For example, section 5.3.4.3.3 in NPL 1, it says that “The Target NSSAI includes at least one S-NSSAI from the Requested NSSAI not available in the current TA”. On the other hand, according to sections 9.3.1.229 and 9.3.1.230 in NPL 3, the Target NSSAI has a single entry per NGAP message that can be sent from the AMF to the RAN. Hence, the Target NSSAI information can only be valid for the TA where the UE is located, i.e., if the UE moves to a cell in another TA within the TA list, the RAN loses the Target NSSAI to be used for the RRC connection redirection to the target cell. As the result, the Target NSSAI information is valid in the current TA. It is not valid when the UE moves to a target cell in another TA within the TA list.

### solution to Problem

In one aspect, a method of a first communication apparatus, the method comprising:
communicating with a second communication apparatus; and
sending Target Network Slice Selection Assistance Information (NSSAI) for a list of a Tracking Area (TA).

In one aspect, a method of a first communication apparatus, the method comprising:
communicating with a second communication apparatus; and
receiving Target Network Slice Selection Assistance Information (NSSAI) for a list of a Tracking Area (TA).

In one aspect, a first communication apparatus comprising:
means for communicating with a second communication apparatus; and
means for sending Target Network Slice Selection Assistance Information (NSSAI) for a list of a Tracking Area (TA).

In one aspect, a first communication apparatus, the method comprising: means for communicating with a second communication apparatus; and means for receiving Target Network Slice Selection Assistance Information (NSSAI) for a list of a Tracking Area (TA).

### BRIEF DESCRIPTION OF DRAWINGS

FIG. 1 is a signaling diagram of the First example of the First Aspect.

FIG. 2 is a signaling diagram of the Second example of the First Aspect.

FIG. 3 is a signaling diagram of the First example of the Second Aspect.

FIG. 4 is a data format definition table of the First example of the Third Aspect.

FIG. 5 is a signaling diagram of the Second example of the Third Aspect.

FIG. 6 is a signaling diagram of the Second example of the Third Aspect.

FIG. 7 is a diagram illustrating a system overview.

FIG. 8 is a block diagram illustrating a UE.

FIG. 9 is a block diagram illustrating an (R)AN node.

FIG. 10 is a diagram illustrating System overview of (R)AN node based on O-RAN architecture.

FIG. 11 is a block diagram illustrating an RU.

FIG. 12 is a block diagram illustrating a DU.

FIG. 13 is a block diagram illustrating a CU.

FIG. 14 is a block diagram illustrating an AMF.

FIG. 15 is a block diagram illustrating a PCF.

FIG. 16 is a block diagram illustrating an AUSF.

FIG. 17 is a block diagram illustrating a UDM.

FIG. 18 is a block diagram illustrating an NSSF.

FIG. 19 is a registration procedure.

FIG. 20 is a UE Configuration Update procedure for access and mobility management related parameters.

### DESCRIPTION OF EMBODIMENTS

### Abbreviations

For the purposes of the present document, the abbreviations given in NPL 4 and the following apply. An abbreviation defined in the present document takes precedence over the definition of the same abbreviation, if any, in NPL 4.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AMF-G Geographically selected Access and Mobility Management Function
AMF-NG Non-Geographically selected Access and Mobility Management Function
ANDSF Access Network Discovery and Selection Function
ARFCN Absolute radio-frequency channel number
AS Access Stratum
ATSSS Access Traffic Steering, Switching, Splitting
ATSSS-LL ATSSS Low-Layer
AUSF Authentication Server Function
AUTN Authentication token
BCCH Broadcast Control Channel
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
ME Mobile Equipment
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
MT Mobile Termination
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NSAG Network Slice Access Stratum Group
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PCO Protocol Configuration Options
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QOS Flow Identifier
QoE Quality of Experience
RA Registration Area
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RSN Redundancy Sequence Number
RSRP Reference Signal Received Power
RSRQ Reference Signal Received Quality
SA NR Standalone New Radio
SBA Service Based Architecture
SBI Service Based Interface
SCP Service Communication Proxy
SD Slice Differentiator
SEAF Security Anchor Functionality
SENSE Signal Level Enhanced Network Selection
SEPP Security Edge Protection Proxy
SIB System Information Block
SINR Signal to Interference plus Noise Ratio
SMF Session Management Function
SMSF Short Message Service Function
SN Sequence Number
SN name Serving Network Name.
SNPN Stand-alone Non-Public Network
S-NSSAI Single Network Slice Selection Assistance Information
SOR Steering of Roaming
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TA Tracking Area
TAI Tracking Area Identity
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UPF User Plane Function
UPSI UE Policy Section Identifier
URLLC Ultra Reliable Low Latency Communication
URRP-AMF UE Reachability Request Parameter for AMF
URSP UE Route Selection Policy
USIM User Services Identity Module
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 3 and the following apply. A term defined in the present document takes precedence over the definition of the same term, if any, in NPL 3.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

The RFSP in this disclosure has the same meaning as “RFSP index” or “RFSP index value”.

The Target NSSAI may be expressed as Target NSSAI information, information regarding the Target NSSAI, information related to the Target NSSAI in this disclosure. The Target NSSAI may include the following information:
One or more S-NSSAI(s)
RFSP that is associated with one or more S-NSSAI(s)
Priority level per each S-NSSAI, if any.

A method of a first communication apparatus according to example aspect of this disclosure includes communicating with a second communication apparatus. The method includes sending Target Network Slice Selection Assistance Information (NSSAI) for a list of a Tracking Area (TA).

A method of a first communication apparatus according to example aspect of this disclosure includes communicating with a second communication apparatus. The method includes receiving Target Network Slice Selection Assistance Information (NSSAI) for a list of a Tracking Area (TA).

A first communication apparatus according to example aspect of this disclosure includes a memory, and at least one hardware processor coupled to the memory. The at least one hardware processor is configured to communicate with a second communication apparatus. The at least one hardware processor is configured to send Target Network Slice Selection Assistance Information (NSSAI) for a list of a Tracking Area (TA).

A first communication apparatus according to example aspect of this disclosure includes a memory, and at least one hardware processor coupled to the memory. The at least one hardware processor is configured to communicate with a second communication apparatus. The at least one hardware processor is configured to receive Target Network Slice Selection Assistance Information (NSSAI) for a list of a Tracking Area (TA).

### First Aspect

While the already Rel-17 agreed Target NSSAI functionality assists steering the UE to a cell in a TA operated in different frequency band where the S-NSSAI(s) from the Target NSSAI are supported, this mechanism of steering the UE is provided via RRC connection redirection or Handover while the UE is in connected mode with established PDU Sessions. However, there are some unclear or problematic situations regarding the Target NSSAI in 3GPP specifications.

For example, it is not clear in 3GPP specifications in a situation where the UE changes its location moving outside of the TA within the Registration area (RA) or the UE changes a CM Connected state to a CM Connected with RRC Inactive state.

For example, in a case where the UE moves to another TAI (e.g., the UE moves to another TA identified by the another TAI from the current TA) within the RA and the UE is also in CM Connected state with established PDU sessions and the UE is in RRC Inactive state (or in Idle state (e.g., RRC Idle state)), the UE cannot be steered to a cell in a TA operated in a different frequency band via RRC Connection redirection or via Handover. This is because the UE mobility in RRC Inactive state (or in Idle state (e.g., RRC Idle state)) is via cell selection and cell reselection controlled by the UE itself and the UE does not have information about the Target NSSAI. For example, in a case where the UE moves to another TA identified by the another TAI within the RA and the UE is in CM Connected state with established PDU sessions and the UE is in RRC Inactive state, the UE cannot be steered to a cell operated in a different frequency band where the S-NSSAI(s) within the Target NSSAI are sup-ported via RRC Connection redirection or via Handover. For example, the current mechanism regarding the Target NSSAI does not consider the UE in RRC Inactive state (or in Idle state), hence the cell which is selected or reselected by the UE in RRC Inactive state (or in Idle state) may not be the appropriate one (e.g., the selected or reselected cell may not support S-NSSAI(s) in the Target NSSAI).

As a result, the UE cannot be steered to a cell in a TA operated in the different frequency band where S-NSSAI(s) from the Target NSSAI are supported when the UE is in RRC Inactive state or in Idle state (e.g., RRC Idle state) because the UE does not have the Target NSSAI information.

For example, after steering the UE to a cell in a TA operated in a different frequency band where the S-NSSAI(s) from the Target NSSAI are supported via RRC Connection redirection procedure while the UE is in connected mode (e.g., CM Connected state), the destination TA may not be in the UE's RA. In this case, the UE may need to re-register with the network in the new TA. However, the UE has no knowledge of the Target NSSAI in order to include the S-NSSAI(s) from the Target NSSAI in the Requested NSSAI within the Registration Request message to the network.

As a result, after the UE is steered to a cell in a TA operated in a different frequency band where S-NSSAI(s) from the Target NSSAI are supported via RRC Connection redirection while the UE is in connected mode (e.g., CM Connected state), the UE does not have a knowledge of the Target NSSAI in order to request registration for the S-NSSAI(s) from the Target NSSAI.

The First Aspect discloses a mechanism enables Target NSSAI transfer from the serving PLMN to the UE so that the UE can be steered to a cell in a TA where the S-NSSAI(s) from the Target NSSAI are supported while the UE is in RRC Inactive or Idle state (e.g., RRC Idle state).

### First Example of the First Aspect

The First example of the First Aspect allows for Target NSSAI provision to the UE during registration procedure.

The detailed process of the First example of the First Aspect in FIG. 1 is described below:
1. A UE 3 is camped on Cell-1 of RAN-1 501 and the UE 3 triggers a registration with an AMF 70 of the serving PLMN. The Cell-1 may be operated by the RAN-1 501 (or a RAN node-1 501). The UE 3 establishes RRC connection with the RAN-1 501 and in an AS message to the RAN-1 501 the UE 3 includes a Registration Request message in a NAS-Container. For example, the UE 3 includes, in the NAS-Container of the AS message, the Registration Request message. The UE 3 sends the AS message to the RAN-1 501. The AS message could be an RRC Connection Setup Complete message or any other RRC message on the interface between the UE 3 and the RAN-1 501. If the UE 3 supports a Target NSSAI feature, the UE 3 may include in the Registration Request message its support for the Target NSSAI feature. For example, if the UE 3 supports the Target NSSAI feature, the UE 3 may include in the Registration Request message Target NSSAI feature support indication. The Target NSSAI feature support indication may indicate that the UE 3 supports the Target NSSAI.

For example, the UE 3 is Target NSSAI supporting UE or the UE supporting the Target NSSAI feature if the UE 3, provided with the Target NSSAI information, is capable to use the Target NSSAI information for steering to a cell which supports one or more S-NSSAI(s) from the Target NSSAI.

For example, the UE 3 is Target NSSAI supporting UE or the UE supporting the Target NSSAI feature if the UE 3, provided with the Target NSSAI information, is capable to use the Target NSSAI information for steering to a cell which supports one or more S-NSSAI(s) from the Target NSSAI when the requested S-NSSAI(s) (e.g. S-NSSAI(s) in the Requested NSSAI or S-NSSAI(s) to be included in the Requested NSSAI) are not available in the registration procedure or when the serving S-NSSAI (e.g., S-NSSAI(s) in the Allowed NSSAI on which there is an established PDU session, active or suspended) is not available during the UE 3 mobility in Idle mode (e.g., RRC Idle mode) or in RRC Inactive mode. The Idle mode or the RRC Idle mode may be expressed as Idle state or RRC Idle state in this disclosure. The RRC Inactive mode may be expressed as RRC Inactive state in this disclosure. The Cell-1 from RAN-1 501 or the Cell-1 of RAN-1 501 may mean that Cell-1 controlled or operated or managed by RAN-1 501 in this disclosure. The RAN-1 501 may be expressed as (R)AN Node-1 501 in this disclosure.
2. The RAN-1 501 forwards the Registration Request message from the UE 3 to the AMF 70 within a message (e.g., a UE Initial message, an Initial UE message or any other messages).
3. The AMF 70 stores the UE 3's capability to support the Target NSSAI feature in a UE context for the UE 3 within the AMF 70. The UE 3's capability to support the Target NSSAI feature may be expressed as UE support for Target NSSAI feature capability in this disclosure. The AMF 70 may store the UE support for Target NSSAI feature capability in the UE context for the UE 3 within the AMF 70. The AMF 70 may store the UE support for Target NSSAI feature capability in a UE 3's profile within the AMF 70.
4. The UE 3 registration with the AMF 70 of the serving PLMN continues as per Section 4.2.2.2.2 in NPL 2. For example, steps 4-19c in the registration procedure of the Section 4.2.2.2.2 may be performed.
5. If the UE 3 indicated support for the Target NSSAI feature in the Registration Request message at step 1, the AMF 70 fetches the Target NSSAI information which may be stored in the UDM 75 or it is configured in the AMF 70 based on operator policy. The AMF 70 may fetch the Target NSSAI information from an NSSF 76 or an OAM. The AMF 70 may make inquiries with the NSSF 76 when deciding which S-NSSAI(s) are included in the Target NSSAI.

For example, the AMF 70 sends an Nnssf_NSSelection_Get message to the NSSF 76 including a list of TAIs in addition to the existing parameters in order to obtain the Target NSSAI per TAI from the NSSF 76. The list of TAIs can be equal to a TAI list for the UE 3 that is going to be provided to the UE 3. The list of TAIs may include all TAIs that the AMF 70 manages (e.g. all TAs of the RA).

Upon reception of the Nnssf_NSSelection_Get message by the NSSF 76 including the list of TAIs, the NSSF 76 constructs the Target NSSAI(s) per TAI for all TAIs that are indicated by the list of TAIs. Then the NSSF 76 sends an Nnssf_NSSelection_Get response message to the AMF 70 including the Target NSSAI(s) per TAI in addition to the existing parameters.

For example, in order to find a RFSP for each Target NSSAI, the AMF 70 sends an Npcf_AMPolicyControl_Create message to the PCF 73 including the list of TAIs and Target NSSAI per TAI in addition to the existing parameters in order to obtain RFSP(s) for each Target NSSAs per TAI from the PCF 73. The list of TAIs can be equal to a TAI list for the UE 3 that is going to be provided to the UE 3. The list of TAIs may include all TAIs that the AMF 70 manages (e.g. all TAs of the RA).

Upon reception of the Npcf_AMPolicyControl_Create message by the PCF 73 including the list of TAIs and Target NSSAI per TAI, the PCF 73 finds an RFSP for the Target NSSAI for each TAI. Then the PCF 73 sends an Npcf_AMPolicy Control_Create response message to the AMF 70 including RFSPs for each Target NSSAs per TAI in addition to existing parameters.

The Target NSSAI may contain one or more S-NSSAI(s) among which one or more S-NSSAI(s) for which the UE 3 is subscribed to however, these UE 3 subscribed S-NSSAI(s) were not available in the UE 3's location, e.g. cell or TA or RA, during the registration procedure.

The Target NSSAI may also contain S-NSSAI(s) that were rejected during the registration procedure, Allowed NSSAI(s) and Configured NSSAI(s).

The Target NSSAI may include at least one S-NSSAI from the Requested NSSAI not available in the current TA, but available in another TA in different frequency band possibly overlapping with the current TA, and optionally additional S-NSSAIs from the Requested NSSAI that are configured to be available within the same TAs as the S-NSSAIs not available in the current TA.

The Target NSSAI may be excluding some of the Allowed NSSAIs and include some of the rejected S-NSSAIs due to lack of support in the TA where the UE is located based on network policies that are in line with customer and operator agreements. The Target NSSAI may only include S-NSSAIs that can be provided in an Allowed NSSAI for the UE. The Target NSSAI may include e.g.:
all or a subset of the Rejected S-NSSAIs for RA when none of the S-NSSAIs in the Requested S-NSSAI were available in the TA where the UE is;
all the S-NSSAIs of the Allowed NSSAI and all or a subset of the Rejected S-NSSAIs for the RA;
a subset of the S-NSSAIs in the Allowed NSSAI and all or a subset of the Rejected S-NSSAIs for the RA if the operator policy is to prefer this Target S-NSSAI to the Allowed NSSAI.

The Target NSSAI information may be different for the TA(s) of the UE 3's RA, i.e., the S-NSSAI(s) in the Target NSSAI may vary with TA granularity, i.e. in different TA(s) of the UE 3's RA the Target NSSAI may contain different set of S-NSSAI(s). In this case the AMF 70 may also provide to the UE 3 during the registration procedure, in a Registration Accept message, a list of TA(s) for each Target NSSAI, i.e., what Target NSSAI is applicable in each TA, so that the UE 3 is aware what Target NSSAI is supported in each TA. Also, the Target NSSAI may have universal applicability, i.e., one Target NSSAI may be provided to the UE 3 during the registration procedure. The Target NSSAI may be configured per serving S-NSSAI applicability. For example, for each S-NSSAI in the Allowed NSSAI one Target NSSAI may be applicable. For example, a separate Target NSSAI may be provided to the UE 3 for each S-NSSAI in the UE 3's Allowed NSSAI.

In building the Target NSSAI, i.e., when deciding which S-NSSAI(s) are part of the Target NSSAI for the UE 3, the AMF 70 may consider information like S-NSSAI priority which may be subscription based S-NSSAI priority available in the UDM 75 as a subscription attribute for each UE, i.e. each UE may have different priority for the same S-NSSAI depending on the UE's type or depending on the user priority or on any other user or UE attributes. The AMF 70 may store the Target NSSAI for the UE 3 in the UE context for the UE 3 within the AMF 70 and transfer the Target NSSAI to the target AMF in UE 3 mobility between AMFs so that the Target NSSAI is available in the target AMF.

For example, the AMF 70 may configure the Target NSSAI based on at least one of operator policy and S-NSSAI(s) for the UE 3 (e.g., the Allowed NSSAI for the UE 3, the Configured NSSAI for the UE 3, Rejected NSSAI for the UE 3) etc.

For example, even if the UE 3 does not indicate the support for the Target NSSAI feature in the Registration Request message at step 1, the AMF 70 may fetch the Target NSSAI information from the UDM 75 or the NSSF 76 or the OAM, or the AMF 70 may configure the Target NSSAI.

The AMF 70 may send the Target NSSAI which is fetched or is configured by the AMF 70 to the UDM 75, the NSSF 76, the OAM or any other network nodes. The UDM 75, the NSSF 76, the OAM or any other network nodes may store the Target NSSAI received from the AMF 70. In a case where the UDM 75, the NSSF 76, the OAM or any other network nodes receives, from the AMF 70, a request for sending the Target NSSAI, the UDM 75, the NSSF 76, the OAM or any other network nodes may send the requested Target NSSAI to the AMF 70.
6. If the UE 3 indicated support for Target NSSAI in the Registration Request message during the registration procedure, the AMF 70 delivers the Target NSSAI information to the UE 3 within the Registration Accept message.

For example, the AMF 70 may send, to the UE 3, the Registration Accept message including the Target NSSAI. The Registration Accept message may include at least one of an Allowed NSSAI (e.g., an Allowed NSSAI for the UE 3) and a Rejected NSSAI (e.g., a Rejected NSSAI for the UE 3).

For example, even if the UE 3 does not indicate the support for Target NSSAI in the Registration Request message during the registration procedure (e.g., even if the UE 3 does not include the Target NSSAI feature support indication in the Registration Request message at step 1), the AMF 70 may deliver the Target NSSAI information to the UE 3 within the Registration Accept message. The delivered Target NSSAI may be fetched or configured by the AMF 70 in step 5.
7. The UE 3 stores the Target NSSAI information within the UE 3. The UE 3 stores the received Target NSSAI from the AMF 70. The NAS of the UE 3 provides the Target NSSAI information to the AS of the UE 3 for the purpose of steering the UE 3 to a S-NSSAI(s) within the Target NSSAI.

For example, the NAS of the UE 3 may provide the Target NSSAI information to the AS of the UE 3 for the purpose of steering the UE 3 to a S-NSSAI(s) within the Target NSSAI when the S-NSSAI(s) requested by the UE 3 or the serving S-NSSAI(s) are not available or are not supported.

When the S-NSSAI(s) requested by the UE 3 or the serving S-NSSAI(s) are not available or not supported, e. g., if the S-NSSAI(s) requested by the UE 3 were rejected during the registration procedure or if at the UE 3 mobility in Idle mode or in RRC Inactive mode the serving S-NSSAI(s) are not available and if the UE 3 was provided with Target NSSAI information, the UE 3 selects or reselects a cell which supports one or more S-NSSAIs from the Target NSSAI.

For example, the UE 3 may select or reselect a cell which supports one or more S-NSSAIs within the Target NSSAI.

For example, in a case where due to mobility of the UE 3 in Idle mode or RRC Inactive mode, the S-NSSAI(s) requested by the UE 3 (e.g., S-NSSAI(s) included in the Requested NSSAI of the Registration Request message in step 1) are not available, the UE 3 may select or reselect a cell which supports one or more S-NSSAIs within the Target NSSAI.

For example, in a case where due to mobility of the UE 3 in Idle mode or RRC Inactive mode, the S-NSSAI(s) requested by the UE 3 (e.g., S-NSSAI(s) included in the Requested NSSAI of the Registration Request message in step 1) are not available, the UE 3 may select or reselect a cell which supports one or more S-NSSAIs within the Target NSSAI.

For example, in a case where the S-NSSAI(s) requested by the UE 3 (e.g., S-NSSAI(s) included in the Requested NSSAI of the Registration Request message in step 1) are rejected, the UE 3 may select or reselect a cell which supports one or more S-NSSAIs within the Target NSSAI. The Target NSSAI may include the rejected S-NSSAI(s).

For example, in a case where due to mobility of the UE 3 in Idle mode or RRC Inactive mode, the serving S-NSSAI(s) are not available, the UE 3 may select or reselect a cell which supports one or more S-NSSAIs within the Target NSSAI.

For example, the UE 3 may select or reselect a cell which supports one or more S-NSSAIs within the Target NSSAI in a case where the UE 3 is in Idle state or in RRC Inactive state and the UE 3 receives the Target NSSAI from the AMF 70.

For example, the UE 3 may select or reselect a cell which supports one or more S-NSSAIs within the Target NSSAI based on system information which is broadcasted by cell(s).

For example, the UE 3 may receive information related to Network Slice AS Group(s) (NSAG(s)) in the Registration Accept message at step 6 or any other message from the AMF 70. The information related to NSAG(s) may include S-NSSAI(s) which are grouped. For example, the information related to NSAG(s) may include information indicating that S-NSSAI 1 and S-NSSAI 2 are grouped into Group 1 and information indicating that S-NSSAI 3 and S-NSSAI 4 are grouped into Group 2.

For example, the UE 3 may receive system information from cell(s). The system information may include another information related to NSAG(s). For example, the another information related to NSAG(s) may include information indicating the Group 1.

For example, it assumes that a case where the UE 3 (e.g., the UE 3 in Idle state or in RRC Inactive state) receives Target NSSAI including S-NSSAI 2 and the UE 3 receives the above information indicating that S-NSSAI 2 is grouped into Group 2 and the UE 3 receives, from Cell-2 of RAN-2 502, the above system information including information which indicates the Group 2. In this case, the UE 3 may determine that the Cell-2 of the RAN-2 502 supports S-NSSAI 2 included in the Target NSSAI, and the UE 3 may select or reselect the Cell-2 of the RAN-2 502.

The Cell-2 from RAN-2 502 or the Cell-2 of RAN-2 502 may mean that Cell-2controlled or operated or managed by RAN-2 502 in this disclosure. The RAN-2502 may be expressed as (R)AN Node-2 502 in this disclosure.

The UE 3 may determine that the serving S-NSSAI(s) (e.g., S-NSSAI(s) in the Allowed NSSAI) is not available or not supported based on the above information related to NSAG(s) and the another information related to NSAG(s). For example, it assumes that the UE 3 (e.g., the UE 3 in Idle state or in RRC Inactive state) stores the Allowed NSSAI including S-NSSAI 1 and the Target NSSAI including S-NSSAI 2 at step 6 and the UE 3 receives the information related to NSAG(s) indicating that S-NSSAI 1 is grouped into Group 1 and S-NSSAI 2 is grouped into Group 2. Then, in a case where the UE 3 receives the another information indicating Group 2 (e.g., due to movement of the UE 3 in Idle state or in RRC Inactive state), the UE 3 may determine that the serving S-NSSAI(s) (e.g., S-NSSAI 1 included in the Allowed NSSAI) is not available or not supported (e.g., at the current location). In this case, the UE 3 also may determine that S-NSSAI 2 included in the Target NSSAI is available or supported at the current location, then the UE 3 may select or reselect cell which supports S-NSSAI 2 (e.g., the UE 3 may select or reselect the cell which the another information indicating Group 2 is broadcasted).
8. If the selected target cell or the reselected cell, e.g. Cell-2 from RAN-2 502, supports one or more S-NSSAI(s) from the Target NSSAI however, the Cell-2 from RAN-2 belongs to a new TA for which the supported S-NSSAI(s) from the Target NSSAI are not in the UE 3's Allowed NSSAI, the UE 3 triggers the registration procedure from Cell-2 of RAN-2 502 for the S-NSSAI(s) from the Target NSSAI which are supported in the target Cell-2 of RAN-2 i.e. the UE 3 includes the S-NSSAI(s) from the Target NSSAI supported in Cell-2 of RAN-2 502 in the Requested NSSAI within the Registration Request message. The UE 3 may also include an indication for Target NSSAI support in the Registration Request message.

For example, in a case where the UE 3 selects or reselects the Cell-2 in the manner mentioned at step 7 (e.g., in a case where the UE 3 selects or reselects the Cell-2 which supports S-NSSAI 2 in the Target NSSAI), the UE 3 may include, in the Registration Request message, S-NSSAI 2 which is included in the Target NSSAI. S-NSSAI 2 may be included in Requested NSSAI of the Registration Request message. Then the UE 3 may send, to the RAN-2 502, an AS message including the Registration Request message. The Registration Request message at step 8 may be included in a NAS-Container of the AS message.
9. The RAN-2 502 forwards the Registration Request message from the UE 3 to the AMF 70 within a message (e.g., a UE Initial message, an Initial UE message or any other messages).
10. The UE 3's registration with the AMF 70 of the serving PLMN continues as per section 4.2.2.2.2 in NPL 2. For example, steps 4-25 in the registration procedure of the Section 4.2.2.2.2 may be performed.

### Variant 1 of First Example of the First Aspect

In one example, the Target NSSAI may be delivered to the UE 3 via the UE Configuration Update procedure or via any other existing or new NAS message during or after the registration procedure. For example, the UE 3 receives a Configuration Update Command message including the Target NSSAI.

### Variant 2 of First Example of the First Aspect

In one example, the UE 3 may include the indication for Target NSSAI support in another NAS message. For example, the UE 3 may include the indication for Target NSSAI support in a UL NAS transport message, a Configuration update complete message, an Identity response message, or another existing or new NAS messages.

### Variant 3 of First Example of the First Aspect

In one example, the AMF 70 sends the Npcf_AMPolicy Control_Create message to the PCF 73 including the list of TAIs and Target NSSAI per TAI and the UE radio capability in addition to the existing parameters in order to obtain the RFSP(s) for each Target NSSAI(s) per TAI. The UE radio capability is referred by the PCF 73 for finding an RFSP value in which the UE 3 supports.

I.e., the RFSP value has to be supported by the UE 3. Then the PCF 73 sends the Npcf_AMPolicy Control_Create response message to the AMF 70 including RFSP(s) for each Target NSSAIs per TAI in addition to the existing parameters.

### Variant 4 of First Example of the First Aspect

In one example, if the AMF 70 needs to update the status of the UE 3 in the PCF 73, the AMF 70 sends the Npcf_AMPolicyControl_Update message to the PCF 73 including TAI, the list of TAIs and Target NSSAI per TAI and the UE radio capability in addition to the existing parameters. The list of TAIs can be equal to a TAI list for the UE 3 that is going to be provided to the UE 3.

In order for the AMF 70 to update the UE radio capability in the PCF 73, the UE radio capability change can be a trigger in the Policy Control Request Triggers relevant for AMF and 3GPP access type as described in section 6.1.2.5 in NPL 5.

### Second Example of the First Aspect

The Second example of the First Aspect allows for Target NSSAI provision to the UE during PDU Session establishment procedure.

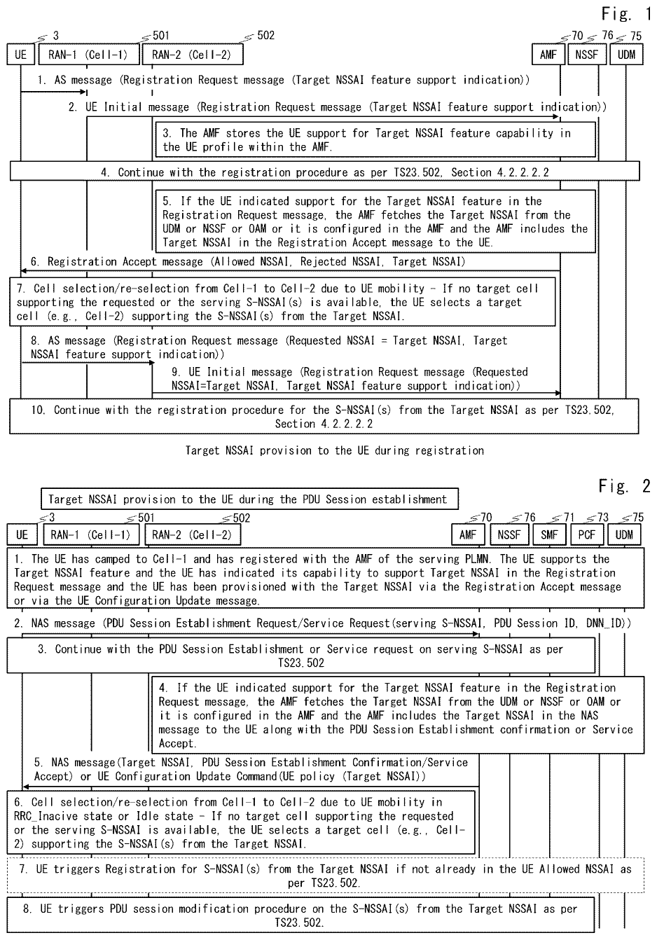

The detailed process of the Second example of the First Aspect in FIG. 2 is described below:
1. The UE 3 has camped to Cell-1 of RAN-1 501 and the UE 3 has registered with the AMF 70 of the serving PLMN. The UE 3 supports the Target NSSAI feature and the UE 3 has indicated its capability to support Target NSSAI in the Registration Request message and the UE 3 has been provisioned with the Target NSSAI via the Registration Accept message or via the UE Configuration Update message as per FIG. 1 in the First example of the First Aspect. The Target NSSAI may be provisioned to the UE 3 even if the UE 3 does not indicate its capability to support Target NSSAI in the Registration Request message as per FIG. 1 in the First example of the First Aspect.

The UE 3 is Target NSSAI supporting UE or the UE supporting the Target NSSAI feature if the UE 3, provided with the Target NSSAI information, is capable to use the Target NSSAI information for steering to a cell which supports one or more S-NSSAI(s) from the Target NSSAI when the requested S-NSSAI(s) (e.g., S-NSSAI(s) in the Requested NSSAI) are not available for registration or when the serving S-NSSAI is not available during the UE 3 mobility in Idle mode (e.g., RRC Idle mode) or in RRC Inactive mode. The definition of Target NSSAI supporting UE or the UE supporting the Target NSSAI feature in the First example of the First Aspect may be applied to the Second example of the First Aspect or other Aspect in this disclosure.

The Target NSSAI may contain one or more S-NSSAI(s) among which one or more S-NSSAI(s) for which the UE 3 is subscribed to however, these UE 3 subscribed S-NSSAI(s) were not available in the UE 3 location, e.g., cell or TA or RA, during the UE 3's registration.

The Target NSSAI may also contain S-NSSAI(s) that were rejected during the UE 3's registration, Allowed NSSAI(s) and Configured NSSAI(s).

The Target NSSAI information may be different for the TAs of the UE 3's RA, i.e., the S-NSSAI(s) in the Target NSSAI may vary with TA granularity, i.e. in different TA(s) of the UE 3's RA the Target NSSAI may contain different set of S-NSSAI(s). In this case the AMF 70 may also provide to the UE 3 during the UE 3 registration, in a Registration Accept message, a list of TA(s) for each Target NSSAI, i.e., what Target NSSAI is applicable in each TA, so that the UE 3 is aware what Target NSSAI is supported in each TA. Also, the Target NSSAI may have universal applicability, i.e., one Target NSSAI provided to the UE 3 during the registration procedure. The Target NSSAI may be configured per serving S-NSSAI applicability. For example, for each S-NSSAI in the Allowed NSSAI one Target NSSAI may be applicable. For example, a separate Target NSSAI may be provided to the UE 3 for each S-NSSAI in the UE 3's Allowed NSSAI.

The definition of the Target NSSAI in the First example of the First Aspect may be applied to the Second example of the First Aspect or other Aspects in this disclosure. The definition of the Target NSSAI in the Second example of the First Aspect may be applied to the First example of the First Aspect or other Aspects in this disclosure.
2. At some point the UE 3 initiates PDU Session Establishment procedure or Service request procedure. For example, the UE 3 may initiate the PDU Session Establishment procedure or the Service request procedure on the already established PDU Session. The UE 3 relays a PDU Session Establishment Request message or a Service Request message in a NAS message to the AMF 70, for example in a NAS Uplink Transfer message or in any other existing or new NAS message on the interface between the UE 3 and AMF 70.

The U 3 may send the NAS message including the PDU Session Establishment Request message or the Service Request message to the AMF 70.

The UE 3 may send the PDU Session Establishment Request message or the Service Request message to the AMF 70. The PDU Session Establishment Request message or the Service Request message may include at least one of S-NSSAI(s) (e.g., serving S-NSSAI(s)), PDU Session ID and DNN_ID.
3. The PDU Session establishment procedure on the requested S-NSSAI (e.g., the S-NSSAI(s) included in the PDU Session Establishment Request message) or the Service Request procedure on the serving S-NSSAI (e.g., the S-NSSAI(s) included in the Service Request message) with the selected SMF 71 continues as per NPL 2.
4. If the UE 3 indicated support for the Target NSSAI feature in the Registration Request message at step 1, the AMF 70 fetches the Target NSSAI information which may be stored in the UDM 75 or is configured in the AMF 70 based on operator policy. The AMF 70 may fetch the Target NSSAI information from an NSSF 76 or an OAM. The AMF 70 may make inquiries with the NSSF 76 when deciding which S-NSSAI(s) are included in the Target NSSAI.

In building the Target NSSAI, i.e., when deciding which S-NSSAI(s) are part of the Target NSSAI for the UE 3, the AMF 70 may consider information like S-NSSAI priority which may be subscription based S-NSSAI priority available in the UDM 75 as a subscription attribute for each UE, i.e. each UE may have different priority for the same S-NSSAI depending on the UE's type or depending on the user priority or on any other user or UE attributes. The AMF 70 may store the Target NSSAI for the UE 3 in the UE context for the UE 3 within the AMF 70 and transfer the Target NSSAI to the target AMF in UE 3 mobility between AMFs so that the Target NSSAI is available in the target AMF.

For example, the AMF 70 may configure the Target NSSAI based on at least one of operator policy and S-NSSAI(s) for the UE 3 (e.g., the Allowed NSSAI for the UE 3, the Configured NSSAI for the UE 3, Rejected NSSAI for the UE 3) etc. For example, even if the UE 3 does not indicate the support for the Target NSSAI feature in the Registration Request message at step 1, the AMF 70 may fetch the Target NSSAI information which may be stored in the UDM 75, or the AMF 70 may configure the Target NSSAI.

The AMF 70 may fetch or configure the Target NSSAI in the same manner as the First example of the First Aspect.

In step 4, the AMF 70 may perform same process in step 5 of the First example of the First Aspect.
5. If the UE 3 indicated support for Target NSSAI in the Registration Request message during the registration procedure, the AMF 70 includes the Target NSSAI in a NAS message to the UE 3 along with a PDU Session Establishment confirmation message (or a PDU Session Establishment accept message) or a Service Request Accept message. Alternatively, the AMF 70 may deliver the Target NSSAI to the UE 3 via a UE Configuration Update Command or via any other existing or new NAS message. The UE Configuration Update Command may be expressed as a Configuration Update Command message in this disclosure. The Target NSSAI may be included in the PDU Session Establishment confirmation message or the PDU Session Establishment accept message. The Target NSSAI may be included in the UE Configuration Update Command. The Target NSSAI may be included in UE policy of the UE Configuration Update Command. For example, even if the UE 3 does not indicate the support for the Target NSSAI feature in the Registration Request message at step 1 or even if the UE 3 does not indicate the support for Target NSSAI in the Registration Request message during the registration procedure, the AMF 70 may send the Target NSSAI to the UE 3. The Target NSSAI may be sent to the UE 3 during the PDU Session Establishment procedure or the Service Request procedure.
6. The UE 3 receives and stores the Target NSSAI information within the UE 3. The NAS of the UE 3 provides the Target NSSAI information to the AS of the UE 3 for the purpose of steering the UE 3 to a S-NSSAI(s) within the Target NSSAI.

For example, the NAS of the UE 3 may provide the Target NSSAI information to the AS of the UE 3 for the purpose of steering the UE 3 to a S-NSSAI(s) within the Target NSSAI when the S-NSSAI(s) requested by the UE 3 or the serving S-NSSAI(s) are not available or are not supported.

When the S-NSSAI(s) requested by the UE 3 or the serving S-NSSAI(s) are not available or not supported, e.g., if the S-NSSAI(s) requested by the UE 3 were rejected during the registration procedure or if at the UE 3 mobility in Idle mode or in RRC Inactive mode the serving S-NSSAI(s) are not available and if the UE 3 was provided with Target NSSAI information, the UE 3 selects or reselects to a cell which supports one or more S-NSSAIs from the Target NSSAI.

For example, the UE 3 may select or reselect a cell in the same manner as the First example of the First Aspect.
7. If the selected target cell or the reselected cell, e.g. Cell-2 from RAN-2 502, supports one or more S-NSSAI(s) from the Target NSSAI however, the Cell-2 from RAN-2 belongs to a new TA for which the supported S-NSSAI(s) from the Target NSSAI are not in the UE 3's Allowed NSSAI (Otherwise, step 7 may be skipped), the UE 3 triggers the registration procedure from Cell-2 of RAN-2 502 for the S-NSSAI(s) from the Target NSSAI which are supported in the target Cell-2 of RAN-2 i.e. the UE 3 includes the S-NSSAI(s) from the Target NSSAI supported in Cell-2 of RAN-2 502 in the Requested NSSAI within the Registration Request message. The UE 3 may also include an indication for Target NSSAI support in the Registration Request message.

For example, in a case where the UE 3 selects or reselects the Cell-2 in the manner mentioned at step 6 (e.g., in a case where the UE 3 selects or reselects the Cell-2 which supports S-NSSAI 2 included in the Target NSSAI in the same manner as the First example of the First Aspect), the UE 3 may include S-NSSAI 2 of the Target NSSAI in the Registration Request message. Then the UE 3 may send, to the RAN-2 502, an AS message including the Registration Request message. The Registration Request message at step 7 may be included in a NAS-Container of the AS message.

For example, in a case where the UE 3 selects or reselects the Cell-2 in the manner mentioned at step 6 (e.g., in a case where the UE 3 selects or reselects the Cell-2 which supports S-NSSAI 2 included in the Target NSSAI in the same manner as the First example of the First Aspect), the UE 3 may include S-NSSAI 2 of the Target NSSAI in the Registration Request message. Then the UE 3 may send, to the AMF 70, the Registration Request message.

For example, the UE 3 may send the Registration Request message in a case where the Allowed NSSAI which the UE 3 stores does not include the S-NSSAI(s) of the Target NSSAI.

For example, assuming the above example, the UE 3 may send the Registration Request message which includes S-NSSAI 2 in a case where the Allowed NSSAI which the UE 3 stores does not include S-NSSAI 2 of the Target NSSAI. S-NSSAI 2 may be included in Requested NSSAI of the Registration Request message.

The registration procedure at step 7 continues as per section 4.2.2.2.2 in NPL 2. For example, steps 4-25 in the registration procedure of the Section 4.2.2.2.2 may be performed.
8. The UE 3 triggers PDU session modification procedure on the S-NSSAI(s) from the Target NSSAI as per NPL 2. For example, the UE 3 and the AMF 70 may perform the PDU session modification procedure for the S-NSSAI(s) from the Target NSSAI.

### Variant 1 of Second Example of the First Aspect

In one example, the Target NSSAI may be defined as new URSP rules in the PCF 73 called ‘Target NSSAI rules’ within the URSP rules or any other notation for the ‘Target NSSAI rules’ which defines the S-NSSAI(s) to which the UE 3 is steered when the S-NSSAI(s) requested by the UE 3 are not available or not supported or when the serving S-NSSAI(s) of the UE 3 become unavailable. The Target NSSAI rules may contain one or more allowed S-NSSAI(s) (e.g., one or more S-NSSAI(s) in Allowed NSSAI), one or more configured S-NSSAI(s) (e.g., one or more S-NSSAI(s) in Configured NSSAI), and at least one rejected S-NSSAI (e.g., at least one S-NSSAI in Rejected NSSAI) which is not available or not supported in the current TA. The granularity of support of the S-NSSAI(s) of the Target NSSAI may be per TA, per RA or per PLMN. Then at step 4 of FIG. 2, if the UE 3 indicated support for the Target NSSAI feature in the Registration Request message, the AMF 70 fetches the Target NSSAI information (e.g., the Target NSSAI rules) from the PCF 73 and the AMF 70 provides the Target NSSAI information to the UE 3 as in step 5 of FIG. 2. Even if the UE 3 does not indicate the support for the Target NSSAI feature in the Registration Request message, the AMF 70 may fetch the Target NSSAI information (e.g., the Target NSSAI rules) from the PCF 73 and the AMF 70 may provide the Target NSSAI information to the UE 3 as in step 5 of FIG. 2.

### Variant 2 of Second Example of the First Aspect

In another example, in step 5 of FIG. 2 the Target NSSAI may be provided to the UE 3 by the PCF 73 itself via the UE Policy update procedure within the URSP rules as per NPL 5. For example, the PCF 73 may provide the above ‘Target NSSAI rules’to the UE 3.

According to the First Aspect and the variants of the First Aspect, it can solve the above-mentioned problem.

For example, the First Aspect and the variants of the First Aspect can solve the problem that there are some unclear or problematic situations regarding the Target NSSAI in 3GPP specifications.

For example, the First Aspect and the variants of the First Aspect can solve the problem that the UE cannot be steered to a cell in a TA operated in the different frequency band where S-NSSAI(s) from the Target NSSAI are supported when the UE is in RRC Inactive state or in Idle state (e.g., RRC Idle state) because the UE does not have the Target NSSAI information.

For example, according to the First Aspect and the variants of the First Aspect, the Target NSSAI is sent to the UE 3 and the UE 3 uses the Target NSSAI for cell selection or cell reselection. It can solve the above-mentioned problem.

### Second Aspect

While the already Rel-17 agreed Target NSSAI functionality assists steering the UE to a cell in a TA operated in different frequency band where the S-NSSAI(s) from the Target NSSAI are supported, this mechanism of steering the UE is provided via RRC connection redirection or Handover while the UE is in connected mode with established PDU Sessions. However, there are some unclear or problematic situations regarding the Target NSSAI in 3GPP specifications.

For example, it is not clear in 3GPP specifications in a situation where the UE changes its location moving outside of the TA within the Registration area (RA) or the UE changes a CM Connected state to a CM Connected with RRC Inactive state.

For example, in a case where the UE moves to another TAI (e.g., another TA identified by the another TAI) within the RA and the UE is also in CM Connected state with established PDU sessions when the UE is in RRC Inactive state (or in Idle state (e.g., RRC Idle state)), the UE cannot be steered to a cell in a TA operated in a different frequency band via RRC Connection redirection or via Handover. This is because the UE mobility in RRC Inactive state (or in Idle state (e.g., RRC Idle state)) is via cell selection and cell reselection controlled by the UE itself and the UE does not have information about the Target NSSAI. For example, in a case where the UE moves to another TA identified by the another TAI within the RA and the UE is in CM Connected state with established PDU sessions and the UE is in RRC Inactive state, the UE cannot be steered to a cell operated in a different frequency band where the S-NSSAI(s) within the Target NSSAI via RRC Connection redirection or via Handover. For example, current mechanism regarding the Target NSSAI does not consider the UE in RRC Inactive state (or in Idle state), hence the cell which selected or reselected by the UE in RRC Inactive state (or in Idle state) may not appropriate (e.g., the selected or reselected cell may not support S-NSSAI(s) in the Target NSSAI).

As the result, the UE cannot be steered to a cell in a TA operated in the different frequency band where S-NSSAI(s) from the Target NSSAI are supported when the UE is in RRC Inactive state or in Idle state (e.g., RRC Idle state) because the UE does not have the Target NSSAI information.

For example, after steering the UE to a cell in a TA operated in a different frequency band where the S-NSSAI(s) from the Target NSSAI are supported via RRC Connection redirection procedure while the UE is in connected mode (e.g., CM Connected state), the destination TA may not be in the UE's RA. In this case, the UE may need to re-register with the network in the new TA. However, the UE has no knowledge of the Target NSSAI in order to include the S-NSSAI(s) from the Target NSSAI in the Requested NSSAI within the Registration Request message to the network.

As the result, after the UE is steered to a cell in a TA operated in a different frequency band where S-NSSAI(s) from the Target NSSAI are supported via RRC Connection redirection while the UE is in connected mode (e.g., CM Connected state), the UE does not have a knowledge of the Target NSSAI in order to request registration for the S-NSSAI(s) from the Target NSSAI.

The Second Aspect discloses a mechanism which allows for Target NSSAI provision to the RAN and to the UE during the UE in connected mode being steered to a cell operated in a different frequency band which supports the S-NSSAI(s) from the Target NSSAI.

### First Example of the Second Aspect

The First example of the Second Aspect discloses a method which allows for the Target NSSAI provision to the UE 3 by the RAN 5 during the UE in connected mode mobility being steered via RRC connection redirection to a target cell from different TA which supports the S-NSSAI(s) from the Target NSSAI.

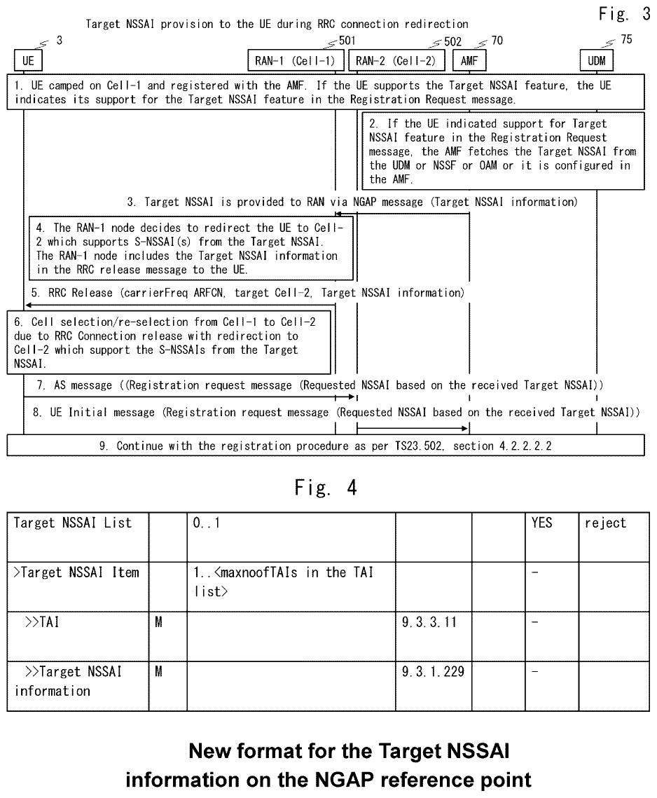

The detailed process of the First example of the Second Aspect in FIG. 3 is described below:
1. The UE 3 has camped to Cell-1 of RAN-1 501 and the UE 3 has registered with the AMF 70 of the serving PLMN. The UE 3 supports the Target NSSAI feature and the UE 3 has indicated its capability to support Target NSSAI in the Registration Request message.

The UE 3 is Target NSSAI supporting UE or the UE supporting the Target NSSAI feature if the UE 3, provided with the Target NSSAI information, is capable to use the Target NSSAI information for steering to a cell which supports one or more S-NSSAI(s) from the Target NSSAI when the requested S-NSSAI(s) (e.g., S-NSSAI(s) in the Requested NSSAI) are not available for registration or when the serving S-NSSAI is not available during the UE 3 mobility (e.g., during the UE 3 mobility in Idle mode (e.g., RRC Idle mode) or in RRC Inactive mode).

The Target NSSAI information may be different for the TAs of the UE RA, i. e., the Target NSSAI may vary with TA granularity. The definition of the Target NSSAI in the First Aspect may be applied to the Second Aspect or other Aspects in this disclosure. The definition of the Target NSSAI in the Second Aspect may be applied to the First Aspect or other Aspects in this disclosure.
2. If the UE 3 indicated support for Target NSSAI feature in the Registration Request message during the registration procedure (e.g., in step 1), the AMF 70 fetches the Target NSSAI from the UDM 75 or NSSF or OAM or it is configured in the AMF 70. The AMF 70 may fetch or configure the Target NSSAI in the same manner as the First aspect. For example, even if the UE 3 does not indicate the support for Target NSSAI feature in the Registration Request message during the registration procedure, the AMF 70 may fetch the Target NSSAI from the UDM 75 or NSSF or OAM, or the AMF 70 may configure the Target NSSAI.
3. If the UE 3 indicated support for Target NSSAI feature in the Registration Request message during the registration procedure, the AMF 70 provides the Target NSSAI to the RAN-1 501 in a N2 message (or an NGAP message), for example in an Initial Context Setup Response message or in an NG Setup Response message or in an AMF Configuration Update message or in any other existing or new message on the Interface between the AMF and RAN. For example, even if the UE 3 does not indicate the support for Target NSSAI feature in the Registration Request message during the registration procedure, the AMF 70 may provide the Target NSSAI to the RAN-1 501.
4. The RAN-1 501 stores the Target NSSAI information in the UE context for the UE 3 in the RAN-1 501. The RAN-1 501 provides the Target NSSAI information to the UE 3. For example, when RAN-1 501 decides to steer the UE 3 to a target cell which supports the S-NSSAI(s) from the Target NSSAI via RRC connection redirection, the RAN-1 501 provides the Target NSSAI information to the UE 3. For example, when the RAN-1 501 decides to steer the UE 3 to a target cell which supports the S-NSSAI(s) from the Target NSSAI via RRC connection redirection, the RAN-1 501 provides the Target NSSAI information to the UE 3 when releasing the RRC connection with the UE 3. For example, in a case where the RAN-1 501 finds or determines cell(s) which supports the S-NSSAI(s) from the Target NSSAI, the RAN-1 501 may send the Target NSSAI to the UE 3.
5. The RAN-1 501 includes in an RRC Release message to the UE 3 the Target NSSAI information along with the target cell identity and sends the RRC Release message to the UE 3. The Target NSSAI information may be included in other message (e.g., other RRC message or other information). The RRC Release message may include at least one of carrier Freq (e.g., information indicating redirected NR frequency), ARFCN (e.g., information indicating ARFCN value) and target Cell-2 (e.g., information indicating a target cell (e.g., Cell-2) or information indicating a cell to be selected or reselected by the UE 3).
6. The UE 3 stores the Target NSSAI information received from the RAN-1 501 and the UE 3 triggers cell selection or cell reselection to the target cell received from RAN-1 501, e.g., Cell-2 of RAN-2 502. The UE 3 may perform cell selection or cell reselection from Cell-1 to Cell-2 due to RRC connection release with redirection to Cell-2 which supports the S-NSSAI(s) from the Target NSSAI. The UE 3 may select or reselect Cell-2 due to RRC connection release with redirection to Cell-2 which supports the S-NSSAI(s) from the Target NSSAI.
7. If the UE 3 is not already registered for all the S-NSSAI(s) from the Target NSSAI and some or all of the non-registered S-NSSAI(s) from the Target NSSAI are supported in the target Cell-2, the UE 3 triggers the registration procedure for these non-registered S-NSSAI(s) from the Target NSSAI that are supported in the Cell-2 and the UE 3 includes these S-NSSAI(s) from the Target NSSAI in the Requested NSSAI in the Registration Request message. The Registration Request message from the UE 3 is relayed to the RAN-2 502 in a AS message.

For example, the UE 3 may send the Registration Request message including the Requested NSSAI which includes S-NSSAI(s) from the Target NSSAI. For example, the UE 3 may send, to the RAN-2 502, the AS message including the Registration Request message.

For example, in a case where the UE 3 selects or reselects the Cell-2 in the manner mentioned at step 6, the UE 3 may include S-NSSAI(s) of the Target NSSAI in the Registration Request message. Then the UE 3 may send, to the RAN-2 502, an AS message including the Registration Request message. The Registration Request message at step 7 may be included in a NAS-Container of the AS message.

For example, in a case where the UE 3 selects or reselects the Cell-2 at step 6, the UE 3 may include S-NSSAI(s) of the Target NSSAI in the Registration Request message. Then the UE 3 may send, to the AMF 70, the Registration Request message.

For example, the UE 3 may send the Registration Request message in a case where the UE 3 does not perform registration procedure for S-NSSAI(s) of the Target NSSAI.

For example, the UE 3 may send the Registration Request message which includes S-NSSAI 1 in a case where the UE 3 does not perform the registration procedure for S-NSSAI 1 of the Target NSSAI. S-NSSAI 1 may be included in Requested NSSAI of the Registration Request message.
8. The RAN-2 502 forwards the Registration Request message from the UE 3 to the AMF 70 in a message (e.g., UE Initial message, an Initial UE message or any other messages).
9. The UE 3's registration procedure for the S-NSSAI(s) from the Target NSSAI continues as per Section 4.2.2.2.2 in NPL 2. For example, steps 4-25 in the registration procedure of the Section 4.2.2.2.2 may be performed.

### Variant 1 of First Example of the Second Aspect

In one example, the NGAP message in step 3 in the First example of the Second Aspect may be triggered by the RAN-1 501 in a case where the UE 3 is in CM-CONNECTED state and the NG-RAN Location reporting procedure, as described in Section 4.10 in NPL 2, is activated and the AMF 70 receives the Location Report message from the RAN-1 501 including new TAI in the UE location parameter.

In this case, the AMF 70 sends an Nnssf_NSSelection_Get message to the NSSF 76 including new TAI in addition to the existing parameters in order to obtain the Target NSSAI for the new TAI from the NSSF 76.

Upon the AMF 70 receiving the new Target NSSAI based on the new TAI from the NSSF 76, the AMF 70 may send an Npcf_AMPolicyControl_Update message to the PCF 73 including new TAI and new Target NSSAI in addition to the existing parameters in order to update the UE status of the UE 3 in the PCF 73.

Then, the AMF 70 sends an Npcf_AMPolicyControl_Create message to the PCF 73 including the new TAI and the new Target NSSAI in addition to the existing parameters in order to obtain RFSP for the new TAI and the new Target NSSAI. Then the AMF 70 may receive the RFSP for the new TAI (e.g., new RFSP) from the PCF 73.

Upon the AMF 70 receiving new RFSP from the PCF 73, the new RFSP together with associated S-NSSAI in the Target NSSAI is sent to the RAN-1 501 by the NGAP message in step 3.

### Variant 2 of First Example of the Second Aspect

In a case where the handover to another RAN node takes place, a Handover Request message, an Early Status Transfer message, an SN Status Transfer message and existing or new XnAP message include the Target NSSAI per TAI.

According to the Second Aspect, it can solve the above-mentioned problem.

For example, the Second Aspect can solve the problem that there are some unclear or problematic situations regarding the Target NSSAI in 3GPP specifications.

For example, the Second Aspect can solve the problem that the UE has no knowledge of the Target NSSAI in order to include the S-NSSAI(s) from the Target NSSAI in the Requested NSSAI within the Registration Request message to the network.

For example, the Second Aspect can solve the problem that after the UE is steered to a cell in a TA operated in a different frequency band where S-NSSAI(s) from the Target NSSAI are supported via RRC Connection redirection while the UE is in connected mode (e.g., CM Connected state), the UE does not have a knowledge of the Target NSSAI in order to request registration for the S-NSSAI(s) from the Target NSSAI.

For example, according to the Second Aspect, after steering the UE to a cell in a TA operated in a different frequency band where the S-NSSAI(s) from the Target NSSAI are supported, the Target NSSAI is sent to the UE 3 and the UE 3 uses the Target NSSAI for the registration procedure. It can solve the above-mentioned problem.

### Third Aspect

The Third Aspect discloses a mechanism which allows the AMF to inform a list of Target NSSAI per TAI for the TAI list that is assigned to the UE.

### First Example of the Third Aspect

The First example of the Third Aspect discloses a method which allows for the Target NSSAI information provision by an AMF 70 to a RAN 5 for a list of TA(s) instead of a Target NSSAI information valid only for the current TA of a UE 3.

According to sections 9.3.1.229 and 9.3.1.230 in NPL 3 the Target NSSAI has a single entry per NGAP message that can be sent from the AMF to the RAN as a Target NSSAI information related to the current TA of the UE 3.

This example of the Third aspect discloses a new format for the Target NSSAI where the Target NSSAI information is provided for a list of TAI as demonstrated in FIG. 4 below. This allows for different Target NSSAI information in the different TAIs of the TAI list.

New parameter a Target NSSAI list information is disclosed by this example. The Target NSSAI list information may be expressed as Target NSSAI List in this disclosure.

The Target NSSAI list information may be set on an INITIAL CONTEXT SETUP REQUEST message, a DOWNLINK NAS TRANSPORT message or other NGAP message that are sent from the AMF 70 to the RAN 5. For example, the Target NSSAI list information may be included in the INITIAL CONTEXT SETUP REQUEST message, the DOWNLINK NAS TRANSPORT message or other NGAP message that are sent from the AMF 70 to the RAN 5.

The Target NSSAI list information contains at least TAI and Target NSSAI information for all TAI(s) in the TAI list that the UE 3 is assigned during the Registration procedure. As the Target NSSAI information contains the up to 8 S-NSSAI(s) in the Target NSSAI and associated Index to RAT/Frequency Selection Priority, the RAN 5 can obtain the Target NSSAI and the Index to RAT/Frequency Selection Priority per TAI for all TAIs that the UE 3 is assigned.

For example, in a case where the TAI list which is assigned to the UE 3 includes TAI 1 and TAI 2, the Target NSSAI list information may include Target NSSAI for TAI 1 (e.g., Target NSSAI for TA 1 identified by TAI 1) and Target NSSAI for TAI 2 (e.g., Target NSSAI for TA 2 identified by TAI 2).

For example, in a case where the current TA (e.g., the TA where the UE 3 locates) is TA 1 and not-current TA (e.g., the TA where the UE 3 does not locate) is TA 2, the Target NSSAI list information may include Target NSSAI for TA 1 (e.g., Target NSSAI for TA 1 identified by TAI 1) and Target NSSAI for TA 2 (e.g., Target NSSAI for TA 2 identified by TAI 2).

Whenever new TAI list is assigned to the UE 3 by the AMF 70 in the NAS procedure, new Target NSSAI list information associated to new TAI list is provided from the AMF 70 to the RAN 5.

### Variant 1 of First Example of the Third Aspect

In one example, the Target NSSAI list information contains at least TAI and Target NSSAI information for all TAI(s) that the RAN 5 has associated with and those of TAIs that are assigned to the TAI list of the UE 3.

### Second Example of the Third Aspect

The Second example of the Third Aspect discloses a method which allows for the Target NSSAI information provision by the AMF 70 to the RAN 5 for all TAIS that the RAN supports using the Interface Management Messages.

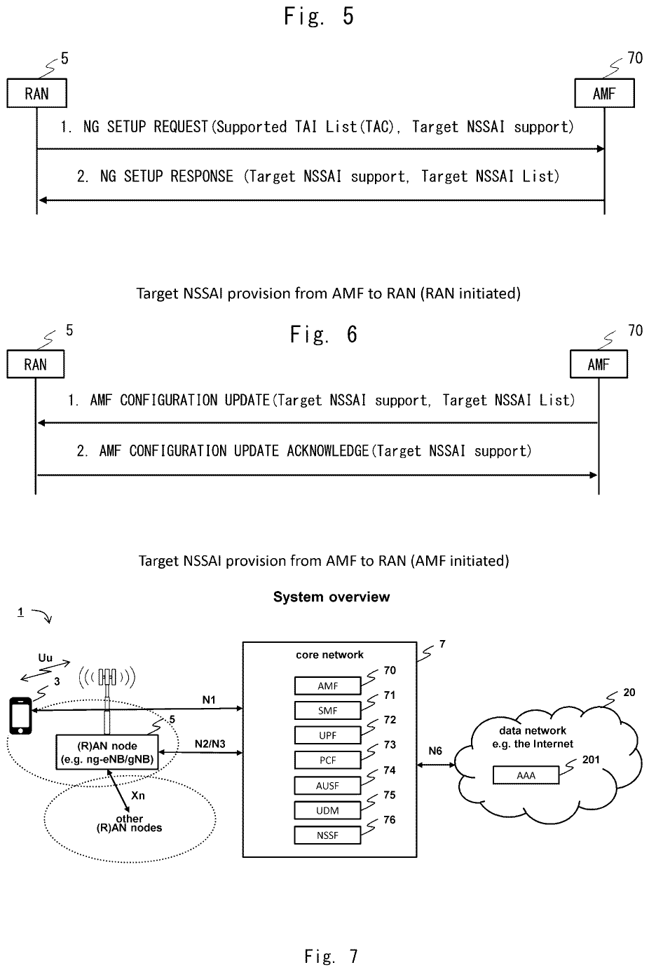

The detailed process of the Second example of the Third Aspect is described by the FIG. 5 and FIG. 6.

The detailed process of the Second example of the Third Aspect in FIG. 5 is described below:
1. The RAN 5 (e.g., a (R)AN node 5) sends an NG SETUP REQUEST message to the AMF 70. For example, this procedure is initiated by the RAN 5 when the RAN 5 is booted up. The NG SETUP REQUEST message includes the Supported TAI List including TAC information and Target NSSAI support parameter. The Target NSSAI support parameter indicates that the RAN 5 supports the Target NSSAI handling. For example, the Target NSSAI support parameter may indicate that the RAN 5 supports at least one of finding cell(s) of TA(s) that can support all the S-NSSAI(s) in the Target S-NSSAIs (or in the Target NSSAI) and initiating RRC redirection procedure towards the found cell. The Target NSSAI support parameter may not be included in the NG SETUP REQUEST message. The Supported TAI List may include TAI(s). The Supported TAI List may indicate a TAI list which is assigned to the UE 3.
2. Upon reception of the NG SETUP REQUEST message from the RAN 5, the AMF 70 constructs the Target NSSAI List for all TAI(s) that are received by the Supported TAI List in step 1 based on the mechanism as described in step 5 in the First example of the First Aspect. For example. the AMF 70 may fetch or configure the Target NSSAI List for all TAI(s) indicated by the Supported TAI List received in step 1 based on the mechanism as described in step 5 in the First example of the First Aspect.

The AMF 70 sends an NG SETUP RESPONSE message to the RAN 5 including the Target NSSAI List and Target NSSAI support parameter. The Target NSSAI support parameter indicates that the AMF 70 supports the Target NSSAI handling.

For example, the Target NSSAI support parameter may indicate that the AMF 70 supports to fetch or configure the Target NSSAI.

For example, the Target NSSAI support parameter may indicate that the AMF 70 supports to fetch or configure the Target NSSAI for all TAI(s) indicated by the Supported TAI List.

For example, the AMF 70 may send the NG SETUP RESPONSE message including the Target NSSAI List and the Target NSSAI support parameter in a case where the AMF 70 receives the NG SETUP REQUEST message including the Supported TAI List and the Target NSSAI support parameter.

For example, the AMF 70 may send the NG SETUP RESPONSE message including the Target NSSAI List and the Target NSSAI support parameter in a case where the AMF 70 receives the NG SETUP REQUEST message including the Supported TAI List.

For example, the AMF 70 may send the NG SETUP RESPONSE message including the Target NSSAI List and the Target NSSAI support parameter even if the received NG SETUP REQUEST message does not include the Target NSSAI support parameter.

The Target NSSAI support parameter may not be included in the NG SETUP RESPONSE message.

When the RAN 5 receives the NG SETUP RESPONSE message including the Target NSSAI List, the RAN 5 stores the Target NSSAI List and uses it for the RRC Connection redirection or Handover procedures for handling of individual UE(s) later. For example, the RAN 5 may use the Target NSSAI List for at least one of finding cell(s) of TA(s) that can support all the S-NSSAI(s) in the Target S-NSSAIs (or in the Target NSSAI) and initiating RRC redirection procedure towards the found cell.

The detailed process of the Second example of the Third Aspect in FIG. 6 is described below:
1. The AMF 70 constructs the Target NSSAI List to all TAI(s) (e.g., the Target NSSAI List for all TAI(s)) that are previously received from the RAN 5 based on the mechanism as described in step 5 in the First example of the First Aspect.

The AMF 70 sends the AMF CONFIGURATION UPDATE message to the RAN 5 including the Target NSSAI List and Target NSSAI support parameter. The Target NSSAI support parameter indicates that the AMF 70 supports the Target NSSAI handling. The Target NSSAI support parameter may be same to the Target NSSAI support parameter in FIG. 5.

For example. the AMF 70 may fetch or configure the Target NSSAI List for all TAI(s) indicated by the RAN 5 or other network nodes based on the mechanism as described in step 5 in the First example of the First Aspect.

The AMF 70 may obtain the TAI(s) in the same manner as FIG. 5. The AMF 70 may receive a message (e.g., the NG SETUP REQUEST message or any other messages) including the Supported TAI List. The Supported TAI List may be same to the Supported TAI List in FIG. 5.

The AMF 70 may perform the process in step 1 periodically, based on local configuration or based on operator policy.

The Target NSSAI support parameter may not be included in the AMF CONFIGURATION UPDATE message.
2. When the RAN 5 receives the AMF CONFIGURATION UPDATE message including the Target NSSAI List, the RAN 5 stores the Target NSSAI List and use it for the RRC Connection redirection or Handover procedures for handling of individual UE(s) later. For example, the RAN 5 may use the Target NSSAI List for at least one of finding cell(s) of TA(s) that can support all the S-NSSAI(s) in the Target S-NSSAIs (or in the Target NSSAI) and initiating RRC redirection procedure towards the found cell.

The RAN 5 sends the AMF CONFIGURATION UPDATE ACKNOWLEDGE message to the AMF 70. The AMF CONFIGURATION UPDATE ACKNOWLEDGE message may include the Target NSSAI support parameter. The Target NSSAI support parameter indicates that the RAN 5 supports the Target NSSAI handling. The Target NSSAI support parameter may be same to the Target NSSAI support parameter in FIG. 5.

### Variant 1 of Second Example of the Third Aspect

In one example, the step 1 in FIG. 5 may be a RAN CONFIGURATION UPDATE message or other new or existing NGAP message from the RAN 5 to the AMF 70 and the step 2 in FIG. 5 may be a RAN CONFIGURATION UPDATE ACKNOWLEDGE message or other new or existing NGAP message from the AMF 70 to the RAN 5.

### Variant 2 of Second Example of the Third Aspect

In one example, the step 1 in FIG. 6 may be another new or existing NGAP message from the AMF 70 to the RAN 5 and the step 2 in FIG. 6 may be another new or existing NGAP message from the RAN 5 to the AMF 70.

The Third Aspect and variants of the Third Aspect may be applied to the First Aspect and the Second Aspect. For example, the Target NSSAI in the First Aspect and the Second Aspect may have the format in FIG. 4. For example, the AMF 70 in the First Aspect or the Second Aspect may fetch or configure the Target NSSAI which has the format in FIG. 4.

According to the Third Aspect and the variants of the Third Aspect, it can solve the above-mentioned problem.

For example, the Third Aspect and the variants of the Third Aspect can solve the problem that there are some unclear or problematic situations regarding the Target NSSAI in 3GPP specifications.

For example, the Third Aspect and the variants of the Third Aspect can solve the problem that if the UE moves to a cell in another TA within the TA list, the RAN loses the Target NSSAI to be used for the RRC connection redirection to the target cell.

For example, the Third Aspect and the variants of the Third Aspect can solve the problem that the Target NSSAI is not valid when the UE moves to a target cell in another TA within the TA list.

For example, according to the Third Aspect and the variants of the Third Aspect, the Target NSSAI information is provided for a list of TAI. It can solve the above-mentioned problem.

### System Overview

FIG. 7 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e., radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice Selection Function (NSSF) 76.

When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPV6, IPv4v6, Ethernet or unstructured data type. The data network may include an AAA 201.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or random Value.
RRC Setup message: This message is sent from the (R)AN node 5 to the UE
3. In addition to the parameters that are disclosed by Aspects in this disclosure, following parameters may be included together in the RRC Setup message.
   masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeas Available, mobility State, ng-5G-S-TMSI-Part2, registeredAMF, selectedPLMN-Identity The UE 3 and the AMF 70 are connected via an appropriate interface (for example the so-called N1 interface and/or the like). The N1 interface is responsible to provide a communication between the UE 3 and the AMF 70 to support NAS signaling. The NI interface may be established over a 3GPP access and over a non-3GPP access. For example, the following messages are communicated over the NI interface.
registration request message: This message is sent from the UE 3 to the AMF 70. In addition to the parameters that are disclosed by Aspects in this disclosure, following parameters may be included together in the registration request message.
   5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### User Equipment (UE)

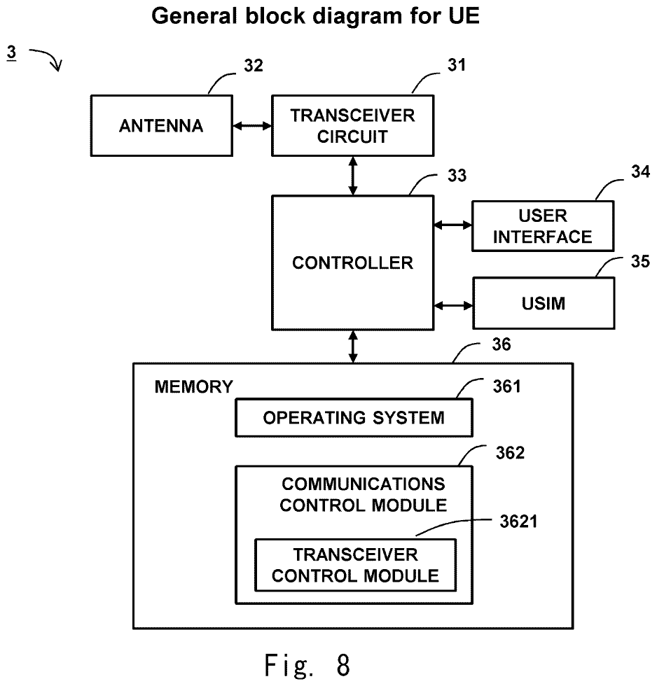

FIG. 8 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in FIG. 8, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g., a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g., smart glasses, a smart watch, a smart ring, or a hearable device).

The UE 3 may be a car, or a connected car, or an autonomous car, or a vehicle device, or a motorcycle or V2X (Vehicle to Everything) communication module (e.g., Vehicle to Vehicle communication module, Vehicle to Infrastructure communication module, Vehicle to People communication module and Vehicle to Network communication module).

### (R)An Node

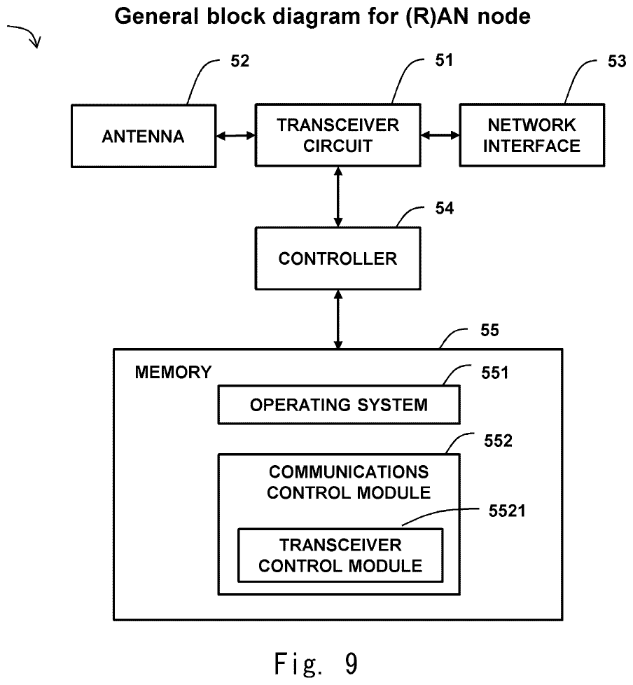

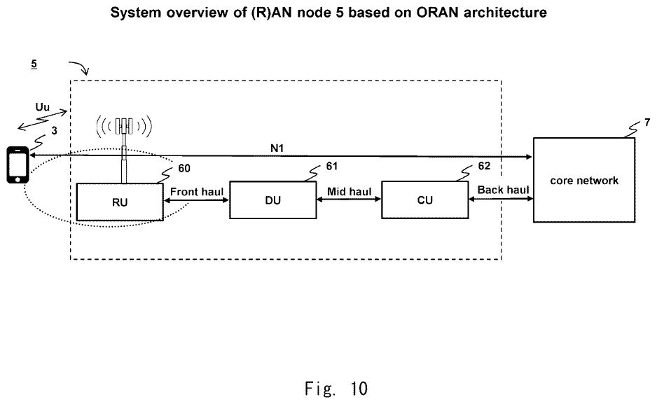

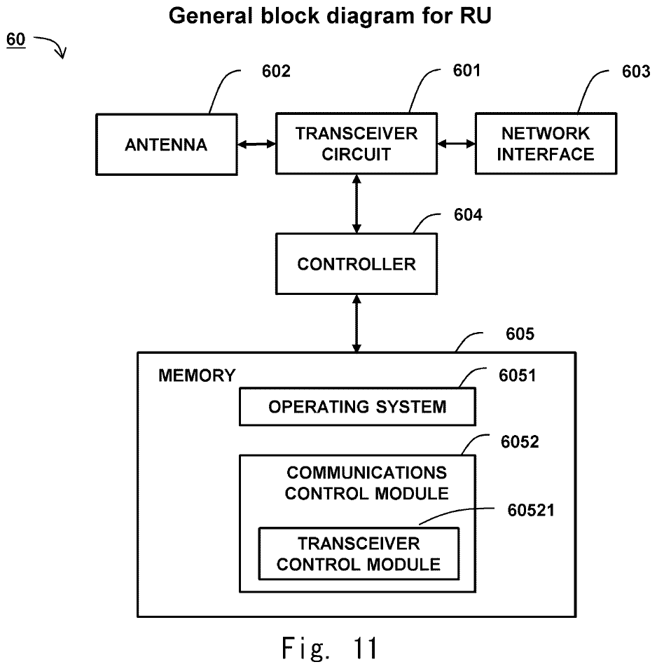

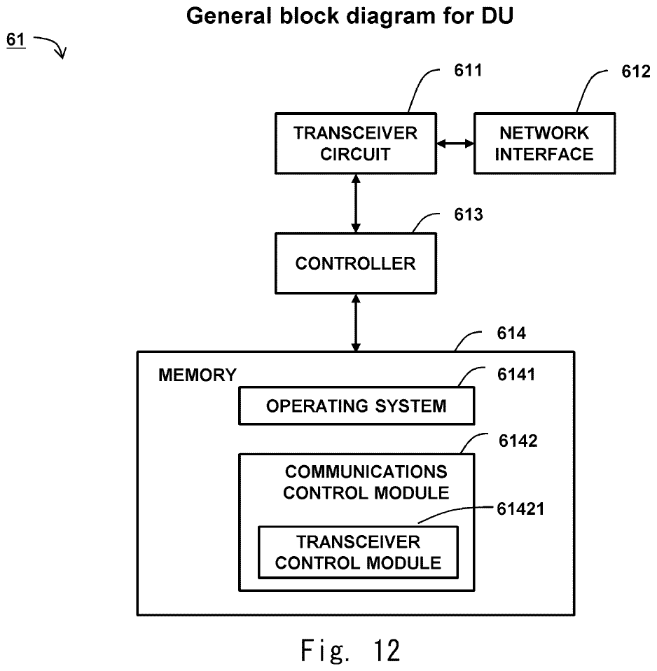

FIG. 9 is a block diagram illustrating the main components of an exemplary (R)AN node 5, for example a base station ('eNB' in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g., RRC connection establishment and other RRC messages), NG Application Protocol (NGAP) messages (i.e., messages by N2 reference point) and Xn application protocol (XnAP) messages (i.e., messages by Xn reference point), etc. Such signalling may also include, for example, broadcast information (e.g., Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

The RAN-1 501 and the RAN-2 502 may have same components to the (R)AN node 5. The (R)AN node 5 may be expressed as a RAN node, RAN, (R)AN etc.

### System Overview of (R)AN Node 5 Based on O-RAN Architecture

FIG. 10 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g., one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### Radio Unit (RU)

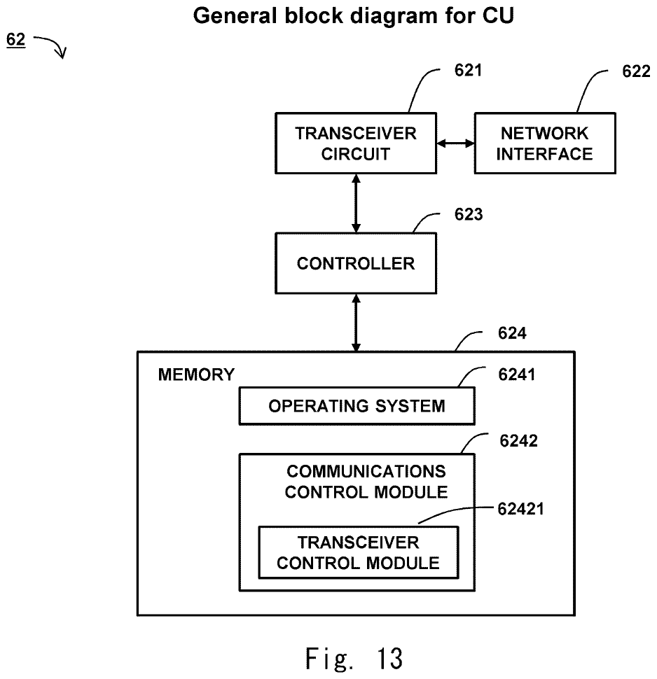

FIG. 11 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g., directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### Distributed Unit (DU)

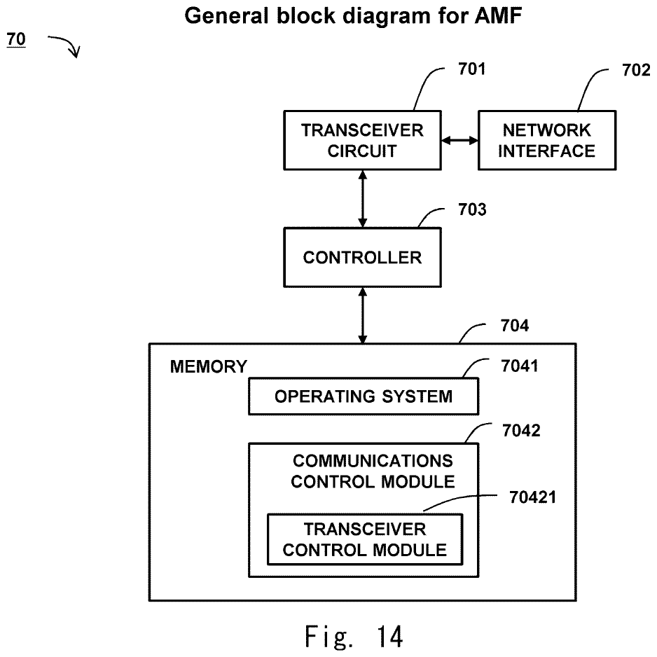

FIG. 12 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### Centralized Unit (CU)

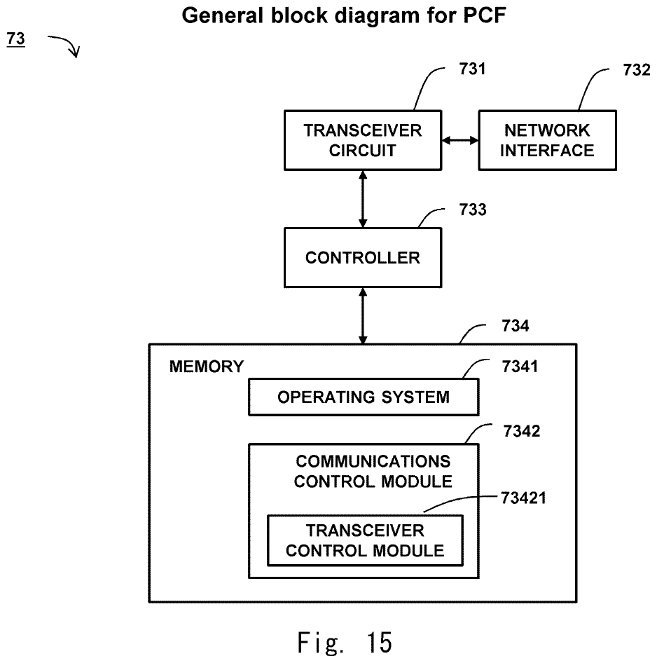

FIG. 13 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### AMF

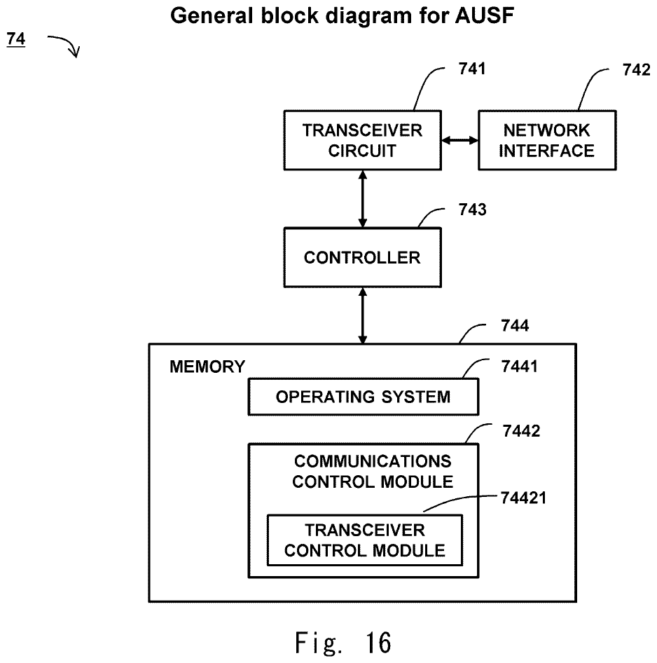

FIG. 14 is a block diagram illustrating the main components of the AMF 70. As shown, the apparatus includes a transceiver circuit 701 which is operable to transmit signals to and to receive signals from other nodes (including the UE 3, the NSSF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 using its transceiver control module 70421 is responsible for handling (generating/sending/receiving) signalling between the AMF 70 and other nodes, such as the UE 3 (e.g., via the (R)AN node 5) and other core network nodes including core network nodes in the HPLMN of the UE 3 when the UE 3 is roaming-in. Such signalling may include, for example, appropriately formatted signalling messages (e.g., a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### PCF

FIG. 15 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g., a removable memory device (RMD)), for example. The software includes, among other things, an operating system 7341 and a communications control module 7342 having at least a transceiver control module 73421. The communications control module 7342 using its transceiver control module 73421 is responsible for handling (generating/sending/receiving) signalling between the PCF 73 and other nodes, such as the AMF 70 and other core network nodes including core network nodes in the HPLMN of the UE 3 when the UE 3 is roaming-in. Such signalling may include, for example, appropriately formatted signalling messages (e.g., a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### AUSF

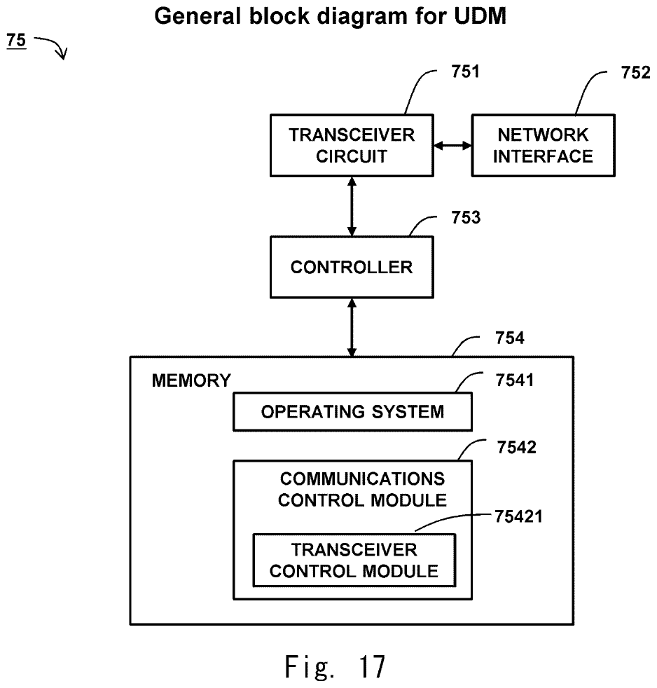

FIG. 16 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g., a removable memory device (RMD)), for example. The software includes, among other things, an operating system 7441 and a communications control module 7442 having at least a transceiver control module 74421. The communications control module 7442 using its transceiver control module 74421 is responsible for handling (generating/sending/receiving) signalling between the AUSF 74 and other nodes, such as the AMF 70 and other core network nodes including core network nodes in the HPLMN of the UE 3 when the UE 3 is roaming-in. Such signalling may include, for example, appropriately formatted signalling messages (e.g., a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### UDM

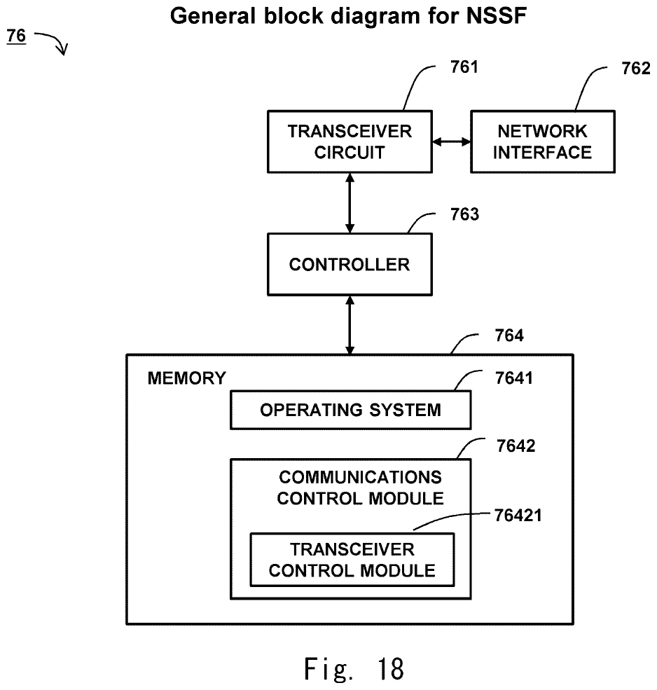

FIG. 17 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 using its transceiver control module 75421 is responsible for handling (generating/sending/receiving) signalling between the UDM 75 and other nodes, such as the AMF 70 and other core network nodes including core network nodes in the VPLMN of the UE 3 when the UE 3 is roaming-out. Such signalling may include, for example, appropriately formatted signalling messages (e.g., a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### NSSF

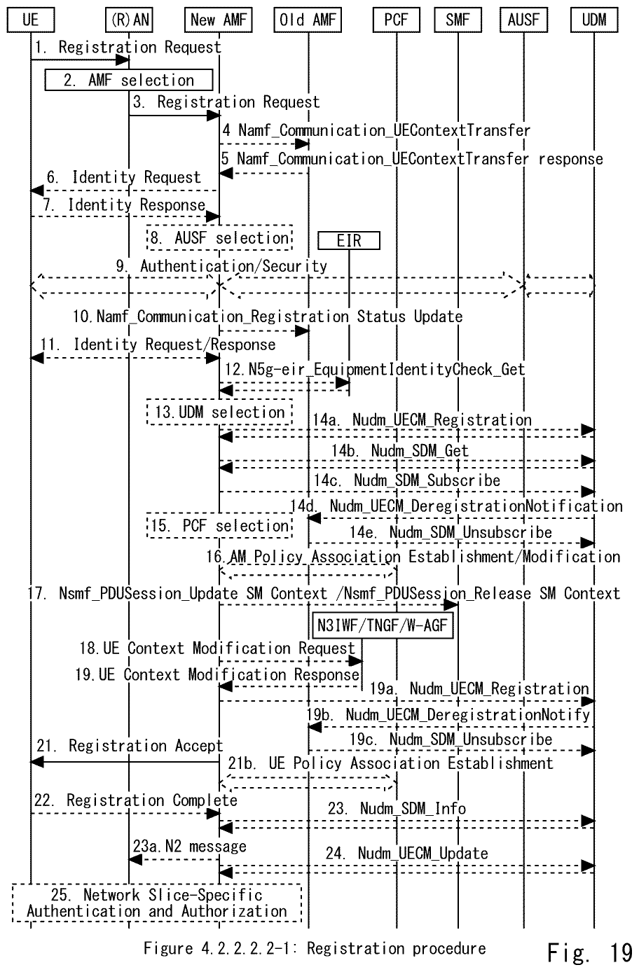

FIG. 18 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSF 76 and other nodes, such as the AMF 70 and other core network nodes (including core network nodes in the VPLMN of the UE 3 when the UE 3 is roaming-out. Such signalling may include, for example, appropriately formatted signalling messages (e.g., a HTTP restful methods based on the service based interfaces) relating to mobility management procedures (for the UE 3).

The NSSF 76 may support the Non-Public Network (NPN), The NPN may be a Stand-alone Non-Public Network (SNPN) or a Public Network Integrated NPN (PNI-NPN).

The whole or part of the example Aspects disclosed above can be described as, but not limited to, the following.

### 5.3.4.3.3 Redirection to Dedicated Frequency Band(s) for an S-NSSAI

If a Network Slice, S-NSSAI, is configured to be available only in TAs covering specific dedicated frequency band(s), then there may be a need to redirect the UE to the dedicated frequency band(s) when such S-NSSAI is requested. If the Requested NSSAI contains S-NSSAI(s) that are not available in the UE's current TA, see clause 5.15.8, the AMF itself or by interacting with the NSSF as described in clause 5.15.5.2.1 may determine a Target NSSAI to be used by the NG-RAN, in addition to the information the AMF receives, such as the Allowed NSSAI and the RFSP for the Allowed NSSAI, to attempt to redirect the UE to a cell and TA in another frequency band and TA that supports the S-NSSAIs in the Target NSSAI. The Target NSSAI includes at least one S-NSSAI from the Requested NSSAI not available in the current TA, but available in another TA in different frequency band possibly overlapping with the current TA, and optionally additional S-NSSAIs from the Requested NSSAI that are configured to be available within the same TAs as the S-NSSAIs not available in the current TA. If the serving PLMN supports the subscription-based restrictions to simultaneous registration of network slices (see clause 5.15.12), and if the UE has NSSRG as part of the subscription information received from the HPLMN, the Target NSSAI includes only S-NSSAIs sharing at least one NSSRG.

The Target NSSAI may be excluding some of the Allowed NSSAIs and include some of the rejected S-NSSAIs due to lack of support in the TA where the UE is located based on network policies that are in line with customer and operator agreements. The Target NSSAI shall only include S-NSSAIs that can be provided in an Allowed NSSAI for the UE. The Target NSSAI may include e.g.:
all or a subset of the Rejected S-NSSAIs for RA when none of the S-NSSAIS in the Requested S-NSSAI were available in the TA where the UE is;
all the S-NSSAIs of the Allowed NSSAI and all or a subset of the Rejected S-NSSAIs for the RA;
a subset of the S-NSSAIs in the Allowed NSSAI and all or a subset of the Rejected S-NSSAIs for the RA if the operator policy is to prefer this Target S-NSSAI to the Allowed NSSAI.

The AMF should retrieve an RFSP Index suitable for the Target NSSAI and includes the RFSP Index in the Target NSSAI information for each TA in the TAI list and sent it to the NG-RAN. The AMF retrieves the RFSP Index from the PCF or, in case PCF is not deployed the AMF determines the RFSP Index according to local configuration. The RFSP index associated to the Target NSSAI is considered if the RAN succeeds to redirect the UE to a new TA outside the RA, otherwise the RFSP index of the Allowed NSSAI is considered.

If the Requested NSSAI contains S-NSSAI(s) which map to S-NSSAI(s) of the HPLMN subject to Network Slice-Specific Authentication and Authorization that are not available in the UE's current TA, the AMF shall proceed with the Network Slice-Specific Authentication and Authorization procedure as described in clause 4.2.9 of TS 23.502 [3]. If the AMF determines a new Allowed NSSAI at the end of Network Slice-Specific Authentication and Authorization steps and some S-NSSAI is not available in the UE's current TA, a Target NSSAI and corresponding RFSP index may be determined and provided to NG-RAN during UE Configuration Update procedure as described in clause 4.2.4.2 of TS 23.502 [3].

The NG-RAN shall attempt to find cells of TAs that can support all the S-NSSAIs in the Target S-NSSAIs for the UE's current TA, and if no such cell of a TA is available the RAN can attempt to select cells of TAs that best match the Target S-NSSAI. The NG-RAN shall attempt to ensure continuity of the PDU Sessions with activated User Plane associated with the S-NSSAIs in the Allowed NSSAI which are in the Target NSSAI. Also, the NG-RAN should attempt to ensure continuity of service for the S-NSSAIs of the Allowed NSSAI also available in the Target NSSAI, before prioritizing cells that are not supporting one or more of the S-NSSAI of the Allowed NSSAI also available in the Target NSSAI.

The NG-RAN attempts to determine target cell(s) supporting the Target NSSAI considering the UE Radio Capabilities (i.e. the AMF (if available in the UE context) shall provide the NG-RAN with the current UE Radio Capability Information or the RACS UE Radio Capability ID when a Target NSSAI is provided, if the NG-RAN had not yet received any of them, or, if the AMF cannot provide any of these, the UE Radio Capability Information may be retrieved by the NG-RAN from the UE).

Once the target cells are determined, the NG-RAN initiates RRC redirection procedure towards the target cells, or the NG-RAN initiates handover for the UE with active PDU Sessions associated with the S-NSSAIs which are in the Target NSSAI, if possible.

After a successful redirection or handover of the UE to a new TA outside the current RA, the UE shall perform a Mobility Registration Update procedure and the S-NSSAIs the new TA supports can be allowed if the UE requests them. In order to ensure that the UE is redirected to a TA outside the current RA, thus triggering a Mobility Registration Update procedure enabling the UE to request the S-NSSAI(s) that were rejected for the RA, the AMF shall set the RA so that the RA does not include TAs supporting the S-NSSAIs rejected for the RA included in the Target NSSAI when the AMF provides a Target NSSAI to the RAN.

### 4.2.2.2.2 General Registration

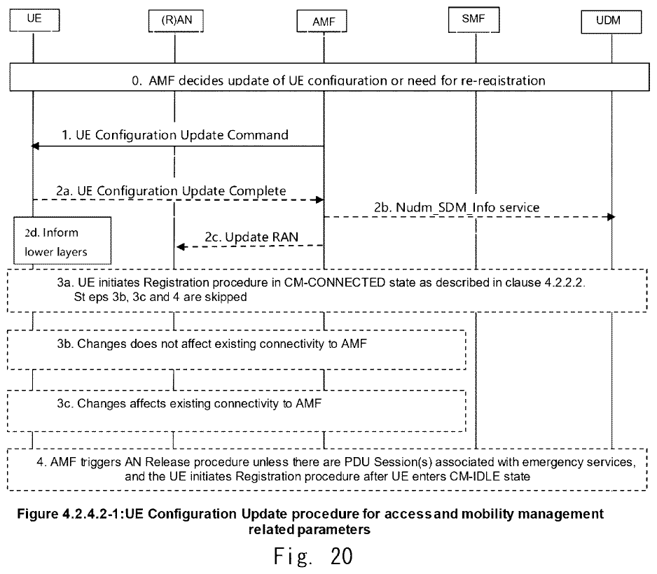

FIG. 19 is a registration procedure.
1. UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [Paging Subgrouping Support Indication], [UE Policy Container (the list of PSIs, indication of UE support for ANDSP and the operating system identifier)] and [UE Radio Capability ID], [Release Request indication], [Paging Restriction Information], PEI, [PLMN with Disaster Condition])).

NOTE 1: The UE Policy Container and its usage is defined in TS 23.503 [20].

In the case of NG-RAN, the AN parameters include e.g. 5G-S-TMSI or GUAMI, the Selected PLMN ID (or PLMN ID and NID, see clause 5.30 of TS 23.501 [2]) and NSSAI information, the AN parameters also include Establishment cause. The Establishment cause provides the reason for requesting the establishment of an RRC connection. Whether and how the UE includes the NSSAI information as part of the AN parameters is dependent on the value of the Access Stratum Connection Establishment NSSAI Inclusion Mode parameter, as specified in clause 5.15.9 of TS 23.501 [2].

The AN parameters shall also include an IAB-Indication if the UE is an IAB-node accessing 5GS.

The Registration type indicates if the UE wants to perform an Initial Registration (i.e. the UE is in RM-DEREGISTERED state), a Mobility Registration Update (i.e. the UE is in RM-REGISTERED state and initiates a Registration procedure due to mobility or due to the UE needs to update its capabilities or protocol parameters, or to request a change of the set of network slices it is allowed to use), a Periodic Registration Update (i.e. the UE is in RM-REGISTERED state and initiates a Registration procedure due to the Periodic Registration Update timer expiry, see clause 4.2.2.2.1), an Emergency Registration (i.e. the UE is in limited service state), a Disaster Roaming Initial Registration, or a Disaster Roaming Mobility Registration Update.

When the UE is using E-UTRA, the UE indicates its support of CIoT 5GS Optimisations, which is relevant for the AMF selection, in the RRC connection establishment signalling associated with the Registration Request.

When the UE is performing an Initial Registration or a Disaster Roaming Registration the UE shall indicate its UE identity in the Registration Request message as follows, listed in decreasing order of preference in the case of registration with a PLMN:
i) a 5G-GUTI mapped from an EPS GUTI, if the UE has a valid EPS GUTI;
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.

NOTE 2: This can also be a 5G-GUTIs assigned via another access type.
v) Otherwise, the UE shall include its SUCI in the Registration Request as defined in TS 33.501 [15].

If the UE is registering with an SNPN, when the UE is performing an Initial Registration the UE shall indicate its UE identity in the Registration Request message as follows, listed in decreasing order of preference:
i) a native 5G-GUTI assigned by the same SNPN to which the UE is attempting to register, if available;
ii) a native 5G-GUTI assigned by any other SNPN along with the NID of the SNPN that assigned the 5G-GUTI, if available;
iii) Otherwise, the UE shall include its SUCI in the Registration Request as defined in TS 33.501 [15].

When the UE performing an Initial Registration has both a valid EPS GUTI and a native 5G-GUTI, the UE shall also indicate the native 5G-GUTI as Additional GUTI. If more than one native 5G-GUTIs are available, the UE shall select the 5G-GUTI in decreasing order of preference among items (ii)-(iv) in the list above.

The NAS message container shall be included if the UE is sending a Registration Request message as an Initial NAS message and the UE has a valid 5G NAS security context and the UE needs to send non-cleartext IEs, see clause 4.4.6 in TS 24.501 [25]. If the UE does not need to send non-cleartext IEs, the UE shall send a Registration Request message without including the NAS message container.

If the UE does not have a valid 5G NAS security context, the UE shall send the Registration Request message without including the NAS message container. The UE shall include the entire Registration Request message (i.e. containing cleartext IEs and non-cleartext IEs) in the NAS message container that is sent as part of the Security Mode Complete message in step 9b.

When the UE is performing an Initial Registration (i.e. the UE is in RM-DEREGISTERED state) with a native 5G-GUTI then the UE shall indicate the related GUAMI information in the AN parameters. When the UE is performing an Initial Registration with its SUCI, the UE shall not indicate any GUAMI information in the AN parameters.

When the UE is performing an Initial Registration or a Mobility Registration and if CIoT 5GS Optimisations are supported the UE shall indicate its Preferred Network Behaviour (see clause 5.31.2 of TS 23.501 [2]). If S1 mode is supported the UE's EPC Preferred Network Behaviour is included in the SI UE network capabilities in the Registration Request message, see clause 8.2.6.1 of TS 24.501 [25].

For an Emergency Registration, the SUCI shall be included if the UE does not have a valid 5G-GUTI available; the PEI shall be included when the UE has no SUPI and no valid 5G-GUTI. In other cases, the 5G-GUTI is included and it indicates the last serving AMF.

The UE may provide the UE's usage setting based on its configuration as defined in clause 5.16.3.7 of TS 23.501 [2]. The UE provides Requested NSSAI as described in clause 5.15.5.2.1 of TS 23.501 [2] and, if the UE supports the subscription-based restrictions to simultaneous registration of network slices, also taking into account the NSSRG Information constraints as described in clause 5.15.12 of TS 23.501 [2] and, in the case of Initial Registration or Mobility Registration Update, the UE includes the Mapping Of Requested NSSAI (if available), which is the mapping of each S-NSSAI of the Requested NSSAI to the HPLMN S-NSSAIs, to ensure that the network is able to verify whether the S-NSSAI(s) in the Requested NSSAI are permitted based on the Subscribed S-NSSAIs. In the case of inter PLMN mobility, if the serving PLMN S-NSSAI(s) corresponding to the established PDU Session(s) are not present in the UE, the associated HPLMN S-NSSAI(s) associated with the established PDU Session(s) shall be provided in the Mapping Of Requested NSSAI as described in clause 5.15.5.2.1 TS 23.501 [2].

The UE includes the Default Configured NSSAI Indication if the UE is using a Default Configured NSSAI, as defined in TS 23.501 [2].

The UE may include UE paging probability information if it supports the assignment of WUS Assistance Information or AMF PEIPS Assistance Information from the AMF (see TS 23.501 [2]).

The UE may include Paging Subgrouping Support Indication as defined in TS 23.501 [2].

In the case of Mobility Registration Update, the UE includes in the List Of PDU Sessions To Be Activated the PDU Sessions for which there are pending uplink data. When the UE includes the List Of PDU Sessions To Be Activated, the UE shall indicate PDU Sessions only associated with the access the Registration Request is related to. As defined in TS 24.501 [25] the UE shall include always-on PDU Sessions which are accepted by the network in the List Of PDU Sessions To Be Activated even if there are no pending uplink data for those PDU Sessions.

NOTE 3: A PDU Session corresponding to a LADN is not included in the List Of PDU Sessions To Be Activated when the UE is outside the area of availability of the LADN.

The UE MM Core Network Capability is provided by the UE and handled by AMF as defined in clause 5.4.4a of TS 23.501 [2]. The UE includes in the UE MM Core Network Capability an indication if it supports Request Type flag “handover” for PDN connectivity request during the attach procedure as defined in clause 5.17.2.3.1 of TS 23.501 [2]. If the UE supports ‘Strictly Periodic Registration Timer Indication’, the UE indicates its capability of ‘Strictly Periodic Registration Timer Indication’ in the UE MM Core Network Capability. If the UE supports CAG, the UE indicates its capability of “CAG supported” in the UE MM Core Network Capability. If the UE operating two or more USIMs, supports and intends to use one or more Multi-USIM feature(s), the UE indicates one or more Multi-USIM specific features described in clause 5.38 of TS 23.501 [2] in the UE MM Core Network Capability.

The UE may provide either the LADN DNN(s) or an Indication Of Requesting LADN Information as described in clause 5.6.5 of TS 23.501 [2].

If available, the last visited TAI shall be included in order to help the AMF produce Registration Area for the UE.

NOTE 4: With NR satellite access, the last visited TAI is determined as specified in clause 5.4.11.6 of TS 23.501 [2].

The Security parameters are used for Authentication and integrity protection, see TS 33.501 [15]. Requested NSSAI indicates the Network Slice Selection Assistance Information (as defined in clause 5.15 of TS 23.501 [2]). The PDU Session status indicates the previously established PDU Sessions in the UE. When the UE is connected to the two AMFs belonging to different PLMN via 3GPP access and non-3GPP access then the PDU Session status indicates the established PDU Session of the current PLMN in the UE.

The Follow-on request is included when the UE has pending uplink signalling and the UE doesn't include List Of PDU Sessions To Be Activated, or the Registration type indicates the UE wants to perform an Emergency Registration. In Initial Registration and Mobility Registration Update, UE provides the UE Requested DRX parameters, as defined in clause 5.4.5 of TS 23.501 [2]. The UE may provide the extended idle mode DRX parameters as defined in clause 5.31.7.2 of TS 23.501 [2] to request extended idle mode DRX.

The UE provides UE Radio Capability Update indication as described in TS 23.501 [2].

The UE includes the MICO mode preference and optionally a Requested Active Time value if the UE wants to use MICO Mode with Active Time.

The UE may indicate its Service Gap Control Capability in the UE MM Core Network Capability, see clause 5.31.16 of TS 23.501 [2].

For a UE with a running Service Gap timer in the UE, the UE shall not set Follow-on Request indication or Uplink data status in the Registration Request message (see clause 5.31.16 of TS 23.501 [2]), except for network access for regulatory prioritized services like Emergency services or exception reporting.

If UE supports RACS and has been assigned UE Radio Capability ID(s), the UE shall indicate a UE Radio Capability ID as defined in clause 5.4.4.1a of TS 23.501 [2] as non-cleartext IE.

The PEI may be retrieved in initial registration from the UE as described in clause 4.2.2.2.1.

If a UE supports the subscription-based restrictions to simultaneous registration of network slices feature, it includes the NSSRG handling support indication in the UE 5GMM Core Network Capability according to clause 5.15.12 of TS 23.501 [2]. The AMF stores whether the UE supports this feature in the UE context.

When a Multi-USIM UE wants to enter CM-IDLE state immediately e.g. after having performed mobility or periodic registration, it includes the Release Request indication and optionally provides Paging Restriction Information.

When the UE is performing a Disaster Roaming Registration, the UE may indicate the PLMN with Disaster Condition for the cases as defined in TS 24.501 [25].
2. If a 5G-S-TMSI or GUAMI is not included or the 5G-S-TMSI or GUAMI does not indicate a valid AMF the (R)AN, based on (R)AT and Requested NSSAI, if available, selects an AMF.

The (R)AN selects an AMF as described in clause 6.3.5 of TS 23.501 [2]. If UE is in CM-CONNECTED state, the (R)AN can forward the Registration Request message to the AMF based on the N2 connection of the UE.

If the (R)AN cannot select an appropriate AMF, it forwards the Registration Request to an AMF which has been configured, in (R)AN, to perform AMF selection.
3. (R)AN to new AMF: N2 message (N2 parameters, Registration Request (as described in step 1) and [LTE-M Indication].

When NG-RAN is used, the N2 parameters include the Selected PLMN ID (or PLMN ID and NID, see clause 5.30 of TS 23.501 [2]), Location Information and Cell Identity related to the cell in which the UE is camping, UE Context Request which indicates that a UE context including security information needs to be setup at the NG-RAN.

When NG-RAN is used, the N2 parameters shall also include the Establishment cause and IAB-Indication if the indication is received in AN parameters in step 1.

Mapping Of Requested NSSAI is provided only if available.

If the Registration type indicated by the UE is Periodic Registration Update, then steps 4 to 19 may be omitted.

When the Establishment cause is associated with priority services (e.g. MPS, MCS), the AMF includes a Message Priority header to indicate priority information. Other NFs relay the priority information by including the Message Priority header in service-based interfaces, as specified in TS 29.500 [17].

The RAT Type the UE is using is determined (see clause 4.2.2.2.1) and based on it the AMF determines whether the UE is performing Inter-RAT mobility to or from NB-IoT. If the AMF receives the LTE M indication, then it considers that the RAT Type is LTE-M and stores the LTE-M Indication in UE Context.

If a UE includes a Preferred Network Behaviour, this defines the Network Behaviour the UE supports and is expecting to be available in the network as defined in clause 5.31.2 of TS 23.501 [2].

If the UE has included the Preferred Network Behaviour and what the UE indicated it supports in Preferred Network Behaviour is incompatible with the network support, the AMF shall reject the Registration Request with an appropriate cause value (e.g. one that avoids retries on this PLMN).

If there is a Service Gap timer running in the UE Context in AMF for the UE and Follow-on Request indication or Uplink data status is included in the Registration Request message, the AMF shall ignore the Follow-on Request indication and Uplink data status and not perform any of the actions related to the status.

If the UE has included a UE Radio Capability ID in step 1 and the AMF supports RACS, the AMF stores the Radio Capability ID in UE context.

For NR satellite access, the AMF may verify the UE location and determine whether the PLMN is allowed to operate at the UE location, as described in clause 5.4.11.4 of TS 23.501 [2]. If the UE receives a Registration Reject message with cause value indicating that the PLMN is not allowed to operate at the present UE location, the UE shall attempt to select a PLMN as specified in TS 23.122 [22].

For a Disaster Roaming Registration, based on the ULI (including Cell ID) received from the NG-RAN, the PLMN with Disaster Condition derived from the UE's 5G-GUTI, derived from the UE's SUCI or indicated by the UE and the local configuration, the AMF determines if Disaster Roaming service can be provided. If the current location is not subject to Disaster Roaming service or the Disaster Roaming service is not provided to the PLMN with Disaster Condition derived from the UE's 5G-GUTI, derived from the UE's SUCI or indicated by UE, then the AMF should reject the Registration Request indicating a suitable Cause value.
4. [Conditional] new AMF to old AMF:

Namf_Communication_UEContextTransfer (complete Registration Request) or new AMF to UDSF: Nudsf_Unstructured Data Management_Query( ).

The new AMF determines the old AMF using the UE's 5G-GUTI. If the new AMF received an NID in the Registration request, it determines that the 5G-GUTI was assigned by an SNPN and determines the old AMF using the 5G-GUTI and NID of the SNPN.

(With UDSF Deployment): If the UE's 5G-GUTI was included in the Registration Request and the serving AMF has changed since last Registration procedure, new AMF and old AMF are in the same AMF Set and UDSF is deployed, the new AMF retrieves the stored UE's SUPI and UE context directly from the UDSF using Nudsf_UnstructuredDataManagement_Query service operation or they can share stored UE context via implementation specific means if UDSF is not deployed. This includes also event subscription information by each NF consumer for the given UE. In this case, the new AMF uses integrity protected complete Registration request NAS message to perform and verify integrity protection.

(Without UDSF Deployment): If the UE's 5G-GUTI was included in the Registration Request and the serving AMF has changed since last Registration procedure, the new AMF may invoke the Namf_Communication_UEContextTransfer service operation on the old AMF including the complete Registration Request NAS message, which may be integrity protected, as well as the Access Type, to request the UE's SUPI and UE Context. See clause 5.2.2.2.2 for details of this service operation. In this case, the old AMF uses either 5G-GUTI and the integrity protected complete Registration request NAS message, or the SUPI and an indication that the UE is validated from the new AMF, to verify integrity protection if the context transfer service operation invocation corresponds to the UE requested. The old AMF also transfers the event subscriptions information by each NF consumer, for the UE, to the new AMF. If the old AMF has not yet reported a non-zero MO Exception Data Counter to the (H-)SMF, the Context Response also includes the MO Exception Data Counter.

If the old AMF has PDU Sessions for another access type (different from the Access Type indicated in this step) and if the old AMF determines that there is no possibility for relocating the N2 interface to the new AMF, the old AMF returns UE's SUPI and indicates that the Registration Request has been validated for integrity protection, but does not include the rest of the UE context.

For inter PLMN mobility, UE Context information includes HPLMN S-NSSAIs corresponding to the Allowed NSSAI for each Access Type, without Allowed NSSAI of old PLMN.

NOTE 5: The new AMF Sets the indication that the UE is validated according to step 9a, if the new AMF has performed successful UE authentication after previous integrity check failure in the old AMF.

NOTE 6: The NF consumers do not need to subscribe for the events once again with the new AMF after the UE is successfully registered with the new AMF.

If the new AMF has already received UE contexts from the old AMF during handover procedure, then step 4,5 and 10 shall be skipped.

For an Emergency Registration, if the UE identifies itself with a 5G-GUTI that is not known to the AMF, steps 4 and 5 are skipped and the AMF immediately requests the SUPI from the UE. If the UE identifies itself with PEI, the SUPI request shall be skipped. Allowing Emergency Registration without a user identity is dependent on local regulations.
5. [Conditional] old AMF to new AMF: Response to Namf_Communication_UEContextTransfer (SUPI, UE Context in AMF (as per Table 5.2.2.2.2-1)) or UDSF to new AMF: Nudsf_Unstructured Data Management_Query( ). The old AMF may start an implementation specific (guard) timer for the UE context.

If the UDSF was queried in step 4, the UDSF responds to the new AMF for the Nudsf_Unstructured Data Management_Query invocation with the related contexts including established PDU Sessions, the old AMF includes SMF information DNN, S-NSSAI(s) and PDU Session ID, active NGAP UE-TNLA bindings to N3IWF/TNGF/W-AGF, the old AMF includes information about the NGAP UE-TNLA bindings. If the Old AMF was queried in step 4, Old AMF responds to the new AMF for the Namf_Communication_UEContextTransfer invocation by including the UE's SUPI and UE Context.

If old AMF holds information about established PDU Session(s) and it is not an Initial Registration, the old AMF includes SMF information, DNN(s), S-NSSAI(s) and PDU Session ID(s).

If old AMF holds UE context established via N3IWF, W-AGF or TNGF, the old AMF includes the CM state via N3IWF, W-AGF or TNGF. If the UE is in CM-CONNECTED state via N3IWF, W-AGF or TNGF, the old AMF includes information about the NGAP UE-TNLA bindings.

If old AMF fails the integrity check of the Registration Request NAS message, the old AMF shall indicate the integrity check failure. If the new AMF is configured to allow emergency services for unauthenticated UE, the new AMF behaves as follows:
If the UE has only an emergency PDU Session, the AMF either skips the authentication and security procedure or accepts that the authentication may fail and continues the Mobility Registration Update procedure; or
If the UE has both emergency and non emergency PDU Sessions and authentication fails, the AMF continues the Mobility Registration Update procedure and deactivates all the non-emergency PDU Sessions as specified in clause 4.3.4.2.

NOTE 7: The new AMF can determine if a PDU Session is used for emergency service by checking whether the DNN matches the emergency DNN.

If old AMF holds information about AM Policy Association and the information about UE Policy Association (i.e. the Policy Control Request Trigger for updating UE Policy as defined in TS 23.503 [20]), the old AMF includes the information about the AM Policy Association, the UE Policy Association and PCF ID. In the roaming case, V-PCF ID and H-PCF ID are included.

If old AMF was a consumer of UE related NWDAF services, the old AMF includes information about active analytics subscriptions, i.e. the Subscription Correlation ID, NWDAF identifier (i.e. Instance ID or Set ID), Analytics ID(s) and associated Analytics specific data in the Namf_Communication_UEContextTransfer response. Usage of the analytics information by the new AMF is specified in TS 23.288[50].

During inter PLMN mobility, the handling of the UE Radio Capability ID in the new AMF is as defined in TS 23.501 [2].

NOTE 8: When new AMF uses UDSF for context retrieval, interactions between old AMF, new AMF and UDSF due to UE signalling on old AMF at the same time is implementation issue.
6. [Conditional] new AMF to UE: Identity Request ( ).

If the SUCI is not provided by the UE nor retrieved from the old AMF the Identity Request procedure is initiated by AMF sending an Identity Request message to the UE requesting the SUCI.
7. [Conditional] UE to new AMF: Identity Response ( ).

The UE responds with an Identity Response message including the SUCI. The UE derives the SUCI by using the provisioned public key of the HPLMN, as specified in TS 33.501 [15].
8. The AMF may decide to initiate UE authentication by invoking an AUSF. In that case, the AMF selects an AUSF based on SUPI or SUCI, as described in clause 6.3.4 of TS 23.501 [2].

If the AMF is configured to support Emergency Registration for unauthenticated SUPIs and the UE indicated Registration type Emergency Registration, the AMF skips the authentication or the AMF accepts that the authentication may fail and continues the Registration procedure.
9a. If authentication is required, the AMF requests it from the AUSF; if Tracing Requirements about the UE are available at the AMF, the AMF provides Tracing Requirements in its request to AUSF. For a Disaster Roaming Registration, the AMF may provide the indication of Disaster Roaming service in its request to AUSF. Upon request from the AMF, the AUSF shall execute authentication of the UE. The authentication is performed as described in TS 33.501 [15]. The AUSF selects a UDM as described in clause 6.3.8 of TS 23.501 [2] and gets the authentication data from UDM.

The AUSF may provide the indication of Disaster Roaming service to UDM if the indication is received from AMF. For a Disaster Roaming Registration, the AUSF executes authentication of the UE based on the local policy and/or local configuration as specified in clause 5.40.4 of TS 23.501 [2] and in TS 33.501 [29].

Once the UE has been authenticated the AUSF provides relevant security related information to the AMF. If the AMF provided a SUCI to AUSF, the AUSF shall return the SUPI to AMF only after the authentication is successful.

After successful authentication in new AMF, which is triggered by the integrity check failure in old AMF at step 5, the new AMF invokes step 4 above again and indicates that the UE is validated (i.e. through the reason parameter as specified in clause 5.2.2.2.2).
9b If NAS security context does not exist, the NAS security initiation is performed as described in TS 33.501 [15]. If the UE had no NAS security context in step 1, the UE includes the full Registration Request message as defined in TS 24.501 [25].

The AMF decides if the Registration Request needs to be rerouted as described in clause 4.2.2.2.3, where the initial AMF refers to the AMF.
9c. The AMF initiates NGAP procedure to provide the 5G-AN with security context as specified in TS 38.413 [10] if the 5G-AN had requested for UE Context. Also, if the AMF decides that EPS fallback is supported (e.g. based on UE capability to support Request Type flag “handover” for PDN connectivity request during the attach procedure as defined in clause 5.17.2.3.1 of TS 23.501 [2], subscription data and local policy), the AMF shall send an indication “Redirection for EPS fallback for voice is possible” towards 5G-AN as specified in TS 38.413 [10]. Otherwise, the AMF indicates “Redirection for EPS fallback for voice is not possible”. In addition, if Tracing Requirements about the UE are available at the AMF, the AMF provides the 5G-AN with Tracing Requirements in the NGAP procedure.
9d. The 5G-AN stores the security context and acknowledges to the AMF. The 5G-AN uses the security context to protect the messages exchanged with the UE as described in TS 33.501 [15].
10. [Conditional] new AMF to old AMF:

Namf_Communication_RegistrationStatus Update (PDU Session ID(s) to be released e.g. due to slice not supported).

If the AMF has changed the new AMF informs the old AMF that the registration of the UE in the new AMF is completed by invoking the Namf_Communication_RegistrationStatus Update service operation.

If the authentication/security procedure fails, then the Registration shall be rejected and the new AMF invokes the Namf_Communication_RegistrationStatus Update service operation with a reject indication towards the old AMF. The old AMF continues as if the UE context transfer service operation was never received.

The new AMF determines the PDU Session(s) that cannot be supported in the new Registration Area in the cases below:
If one or more of the S-NSSAIs used in the old Registration Area cannot be served in the target Registration Area.
When continuity of the PDU Session(s) cannot be supported between networks (e.g. SNPN-SNPN mobility, inter-PLMN mobility where no HR agreement exists).

If any of the cases is met, the new AMF invokes the Namf_Communication_RegistrationStatus Update service operation including the rejected PDU Session ID towards the old AMF. Then the new AMF modifies the PDU Session Status correspondingly. The old AMF informs the corresponding SMF(s) to locally release the UE's SM context by invoking the Nsmf_PDUSession_ReleaseSMContext service operation.

If new AMF received in the UE context transfer in step 5 the information about the AM Policy Association and the UE Policy Association and decides, based on local policies, not to use the PCF(s) identified by the PCF ID(s) for the AM Policy Association and the UE Policy Association, then it will inform the old AMF that the AM Policy Association and the UE Policy Association in the UE context is not used any longer and then the PCF selection is performed in step 15.

If the new AMF received in the UE context transfer in step 5 the information about UE related analytics subscription(s), the new AMF may take over the analytics subscription(s) from the old AMF. Otherwise, if the new AMF instead determines to create new analytics subscription(s), it informs the old AMF about the analytics subscriptions (identified by their Subscription Correlation ID) that are not needed any longer and the old AMF may now unsubscribe those NWDAF analytics subscriptions for the UE according to TS 23.288 [50].
11. [Conditional] new AMF to UE: Identity Request/Response (PEI).

If the PEI was not provided by the UE nor retrieved from the old AMF the Identity Request procedure is initiated by AMF sending an Identity Request message to the UE to retrieve the PEI. The PEI shall be transferred encrypted unless the UE performs Emergency Registration and cannot be authenticated.

For an Emergency Registration, the UE may have included the PEI in the Registration Request. If so, the PEI retrieval is skipped.

If the UE supports RACS as indicated in UE MM Core Network Capability, the AMF shall use the PEI of the UE to obtain the IMEI/TAC for the purpose of RACS operation.
12. Optionally the new AMF initiates ME identity check by invoking the N5g-eir_EquipmentIdentity Check_Get service operation (see clause 5.2.4.2.2).

The PEI check is performed as described in clause 4.7.

For an Emergency Registration, if the PEI is blocked, operator policies determine whether the Emergency Registration procedure continues or is stopped.
13. If step 14 is to be performed, the new AMF, based on the SUPI, selects a UDM, then UDM may select a UDR instance. See clause 6.3.9 of TS 23.501 [2].

The AMF selects a UDM as described in clause 6.3.8 of TS 23.501 [2].
14a-c. If the AMF has changed since the last Registration procedure, if UE Registration type is Initial Registration or Emergency Registration, or if the UE provides a SUPI which does not refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration for the access to be registered (and subscribes to be notified when the UDM deregisters this AMF). The UDM based on the “Registration Type” in the Nudm_UECM_Registration request, can act on SoR information according to TS 23.122 [22]. In this case, if the AMF does not have event exposure subscription information for this UE, the AMF indicates it to UDM. Then, if the UDM has existing applicable event exposure subscriptions for events detected in AMF for this UE or for any of the groups this UE belongs to (possibly retrieved from UDR), UDM invokes the Namf_EventExposure_Subscribe service for recreating the event exposure subscriptions.

The AMF provides the “Homogenous Support of IMS Voice over PS Sessions” indication (see clause 5.16.3.3 of TS 23.501 [2]) to the UDM. The “Homogenous Support of IMS Voice over PS Sessions” indication shall not be included unless the AMF has completed its evaluation of the support of “IMS Voice over PS Session” as specified in clause 5.16.3.2 of TS 23.501 [2].

During initial Registration, if the AMF and UE supports SRVCC from NG-RAN to UTRAN the AMF provides UDM with the UE SRVCC capability.

If the AMF determines that only the UE SRVCC capability has changed, the AMF sends UE SRVCC capability to the UDM.

NOTE 9: At this step, it is possible that the AMF does not have all the information needed to determine the setting of the IMS Voice over PS Session Supported indication for this UE (see clause 5.16.3.2 of TS 23.501 [2]). Hence the AMF can send the “Homogenous Support of IMS Voice over PS Sessions” later on in this procedure.

After AMF has successfully completed the Nudm_UECM_Registration operation and if the AMF does not have subscription data for the UE, the AMF retrieves the Access and Mobility Subscription data, SMF Selection Subscription data, UE context in SMF data and LCS mobile origination using Nudm_SDM_Get. If the AMF already has subscription data for the UE but the SoR Update Indicator in the UE context requires the AMF to retrieve SoR information depending on the NAS Registration Type (“Initial Registration” or “Emergency Registration”) (see Annex C of TS 23.122 [22]), the AMF retrieves the Steering of Roaming information using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE. If the UE is subscribed to MPS in the serving PLMN, “MPS priority” is included in the Access and Mobility Subscription data provided to the AMF. If the UE is subscribed to MCX in the serving PLMN, “MCX priority” is included in the Access and Mobility Subscription data provided to the AMF. The UDM also provides the IAB-Operation allowed indication to AMF as part of the Access and Mobility Subscription data. The AMF shall trigger the setup of the UE context in NG-RAN, or modification of the UE context in NG-RAN if the initial setup is at step 9c, including an indication that the IAB-node is authorized.

For a Disaster Roaming Registration, the AMF may provide the indication of Disaster Roaming service to the UDM. The UDM provides the subscription data for a Disaster Roaming service to the AMF based on the local policy and/or the local configuration as specified in clause 5.40.4 of TS 23.501 [2].

The AMF provides MINT support indication via Nudm_UECM_Registration towards UDM, if UE includes the MINT support indication in the 5GMM capability as specified in clause 5.40.2 of TS 23.501 [2] or if the MINT support indication in the 5GMM capability is changed.

If the AMF receives a priority indication (e.g. MPS, MCX) as part of the Access and Mobility Subscription data, but the UE did not provide an Establishment cause associated with priority services, the AMF shall include a Message Priority header to indicate priority information for all subsequent messages. Other NFs relay the priority information by including the Message Priority header in service-based interfaces, as specified in TS 29.500 [17].

The new AMF provides the Access Type it serves for the UE to the UDM and the Access Type is set to “3GPP access”. The UDM stores the associated Access Type together with the serving AMF and does not remove the AMF identity associated to the other Access Type if any. The UDM may store in UDR information provided at the AMF registration by Nudr_DM_Update.

If the UE was registered in the old AMF for an access and the old and the new AMFs are in the same PLMN, the new AMF sends a separate/independent Nudm_UECM_Registration to update UDM with Access Type set to access used in the old AMF, after the old AMF relocation is successfully completed.

The new AMF creates an UE context for the UE after getting the Access and Mobility Subscription data from the UDM. The Access and Mobility Subscription data includes whether the UE is allowed to include NSSAI in the 3GPP access RRC Connection Establishment in clear text. The Access and Mobility Subscription data may include Enhanced Coverage Restricted information. If received from the UDM and the UE included support for restriction of use of Enhanced Coverage in step 1, the AMF determines whether Enhanced Coverage is restricted or not for the UE as specified in clause 5.31.12 of TS 23.501 [2] and stores the updated Enhanced Coverage Restricted information in the UE context.

The Access and Mobility Subscription data may include the NB-IoT UE Priority.

The subscription data may contain Service Gap Time parameter. If received from the UDM, the AMF stores this Service Gap Time in the UE Context in AMF for the UE.

For an Emergency Registration in which the UE was not successfully authenticated, the AMF shall not register with the UDM.

The AMF enforces the Mobility Restrictions as specified in clause 5.3.4.1.1 of TS 23.501 [2]. For an Emergency Registration, the AMF shall not check for Mobility Restrictions, access restrictions, regional restrictions or subscription restrictions. For an Emergency Registration, the AMF shall ignore any unsuccessful registration response from UDM and continue with the Registration procedure.

NOTE 10: The AMF can, instead of the Nudm_SDM_Get service operation, use the Nudm_SDM_Subscribe service operation with an Immediate Report Indication that triggers the UDM to immediately return the subscribed data if the corresponding feature is supported by both the AMF and the UDM.
14d. When the UDM stores the associated Access Type (e.g. 3GPP) together with the serving AMF as indicated in step 14a, it will cause the UDM to initiate a Nudm_UECM_DeregistrationNotification (see clause 5.2.3.2.2) to the old AMF corresponding to the same (e.g. 3GPP) access, if one exists. If the timer started in step 5 is not running, the old AMF may remove the UE context for the same Access Type. Otherwise, the AMF may remove UE context for the same Access Type when the timer expires. If the serving NF removal reason indicated by the UDM is Initial Registration, then, as described in clause 4.2.2.3.2, the old AMF invokes the Nsmf_PDUSession_ReleaseSMContext (SM Context ID) service operation towards all the associated SMF(s) of the UE to notify that the UE is deregistered from old AMF for the same Access Type. The SMF(s) shall release the PDU Session on getting this notification.

If the old AMF has established an AM Policy Association and a UE Policy Association with the PCF(s) and the old AMF did not transfer the PCF ID(s) to the new AMF (e.g. new AMF is in different PLMN), the old AMF performs an AMF-initiated Policy Association Termination procedure, as defined in clause 4.16.3.2 and performs an AMF-initiated UE Policy Association Termination procedure, as defined in clause 4.16.13.1. In addition, if the old AMF transferred the PCF ID(s) in the UE context but the new AMF informed in step 10 that the AM Policy Association information and UE Policy Association information in the UE context will not be used then the old AMF performs an AMF-initiated Policy Association Termination procedure, as defined in clause 4.16.3.2 and performs an AMF-initiated UE Policy Association Termination procedure, as defined in clause 4.16.13.1.

If the old AMF has an N2 connection for that UE (e.g. because the UE was in RRC Inactive state but has now moved to E-UTRAN or moved to an area not served by the old AMF), the old AMF shall perform AN Release (see clause 4.2.6) with a cause value that indicates that the UE has already locally released the NG-RAN's RRC Connection.

If the UE context in the old AMF contains an Allowed NSSAI including one or more S-NSSAI(s) subject to NSAC, the old AMF upon receipt of the Nudm_UECM_DeregistrationNotification from the UDM, sends an update request message for each S-NSSAI subject to NSAC to the corresponding NSACF(s) with update flag parameter set to decrease (see clause 4.2.11.2).

At the end of registration procedure, the AMF may initiate synchronization of event exposure subscriptions with the UDM if the AMF does not indicate unavailability of event exposure subscription in step 14a.

NOTE 11: The AMF can initiate synchronization with UDM even if events are available in the UE context (e.g. as received from old AMF) at any given time and based on local policy. This can be done during subscription change related event.
14e. [Conditional] If old AMF does not have UE context for another access type (i.e. non-3GPP access), the Old AMF unsubscribes with the UDM for subscription data using Nudm_SDM_unsubscribe.
15. If the AMF decides to initiate PCF communication, the AMF acts as follows.

If the new AMF decides to use the (V-)PCF identified by the (V-)PCF ID included in UE context from the old AMF in step 5, the AMF contacts the (V-)PCF identified by the (V-)PCF ID to obtain policy. If the AMF decides to perform PCF discovery and selection and the AMF selects a (V)-PCF and may select an H-PCF (for roaming scenario) as described in clause 6.3.7.1 of TS 23.501 [2] and according to the V-NRF to H-NRF interaction described in clause 4.3.2.2.3.3.
16. [Optional] new AMF performs an AM Policy Association Establishment/Modification. For an Emergency Registration, this step is skipped.

If the new AMF selects a new (V-)PCF in step 15, the new AMF performs AM Policy Association Establishment with the selected (V-)PCF as defined in clause 4.16.1.2.

If the (V-)PCF identified by the (V-)PCF ID included in UE context from the old AMF is used, the new AMF performs AM Policy Association Modification with the (V-)PCF as defined in clause 4.16.2.1.2.

If the AMF notifies the Mobility Restrictions (e.g. UE location) to the PCF for adjustment, or if the PCF updates the Mobility Restrictions itself due to some conditions (e.g. application in use, time and date), the PCF shall provide the updated Mobility Restrictions to the AMF. If the subscription information includes Tracing Requirements, the AMF provides the PCF with Tracing Requirements.

If the AMF supports DNN replacement, the AMF provides the PCF with the Allowed NSSAI and, if available, the Mapping Of Allowed NSSAI.

If the PCF supports DNN replacement, the PCF provides the AMF with triggers for DNN replacement.
17. [Conditional] AMF to SMF: Nsmf_PDUSession_UpdateSMContext ( ).

For an Emergency Registered UE (see TS 23.501 [2]), this step is applied when the Registration Type is Mobility Registration Update.

The AMF invokes the Nsmf_PDUSession_UpdateSMContext (see clause 5.2.8.2.6) in the following scenario(s):
If the List Of PDU Sessions To Be Activated is included in the Registration Request in step 1, the AMF sends Nsmf_PDUSession_UpdateSMContext Request to SMF(s) associated with the PDU Session(s) in order to activate User Plane connections of these PDU Session(s). Steps from step 5 onwards described in clause 4.2.3.2 are executed to complete the User Plane connection activation without sending the RRC Inactive Assistance Information and without sending MM NAS Service Accept from the AMF to (R)AN described in step 12 of clause 4.2.3.2. When a User Plane connection for a PDU Session is activated, the AS layer in the UE indicates it to the NAS layer.
If the AMF has determined in step 3 that the UE is performing Inter-RAT mobility to or from NB-IoT, the AMF sends Nsmf_PDUSession_UpdateSMContext Request to SMF(s) associated with the UEs PDU Session(s), so the SMF(s) can update them according to the “PDU Session continuity at inter RAT mobility” subscription data. Steps from step 5 onwards described in clause 4.2.3.2 are executed without sending MM NAS Service Accept from the AMF to (R)AN described in step 12 of clause 4.2.3.2.

When the serving AMF has changed, the new serving AMF notifies the SMF for each PDU Session that it has taken over the responsibility of the signalling path towards the UE: the new serving AMF invokes the Nsmf_PDUSession_UpdateSMContext service operation using SMF information received from the old AMF at step 5. It also indicates whether the PDU Session is to be re-activated.

NOTE 12: If the UE moves into a different PLMN, the AMF in the serving PLMN can insert or change the V-SMF(s) in the serving PLMN for Home Routed PDU session(s). In addition, a V-SMF is removed in case the UE moves from a VPLMN into the HPLMN. In these cases, the same procedures described in clause 4.23.3 are applied for the V-SMF change as for the I-SMF change (i.e. by replacing the I-SMF with V-SMF). During inter-PLMN change, if the same SMF is used, session continuity can be supported depending on operator policies.

Steps from step 5 onwards described in clause 4.2.3.2 are executed. In the case that the intermediate UPF insertion, removal, or change is performed for the PDU Session(s) not included in “PDU Session(s) to be re-activated”, the procedure is performed without N11 and N2 interactions to update the N3 user plane between (R)AN and 5GC.

The AMF invokes the Nsmf_PDUSession_ReleaseSMContext service operation towards the SMF in the following scenario:
If any PDU Session status indicates that it is released at the UE, the AMF invokes the Nsmf_PDUSession_ReleaseSMContext service operation towards the SMF in order to release any network resources related to the PDU Session.

If the serving AMF is changed, the new AMF shall wait until step 18 is finished with all the SMFs associated with the UE. Otherwise, steps 19 to 22 can continue in parallel to this step.
18. [Conditional] If the new AMF and the old AMF are in the same PLMN, the new AMF sends a UE Context Modification Request to N3IWF/TNGF/W-AGF as specified in TS 29.413 [64].

If the AMF has changed and the old AMF has indicated that the UE is in CM-CONNECTED state via N3IWF, W-AGF or TNGF and if the new AMF and the old AMF are in the same PLMN, the new AMF creates an NGAP UE association towards the N3IWF/TNGF/W-AGF to which the UE is connected. This automatically releases the existing NGAP UE association between the old AMF and the N3IWF/TNGF/W-AGF.
19. N3IWF/TNGF/W-AGF sends a UE Context Modification Response to the new AMF.
19a. [Conditional] After the new AMF receives the response message from the N3IWF, W-AGF or TNGF in step 19, the new AMF registers with the UDM using Nudm_UECM_Registration as step 14a, but with the Access Type set to “non-3GPP access”. The UDM stores the associated Access Type together with the serving AMF and does not remove the AMF identity associated to the other Access Type if any. The UDM may store in UDR information provided at the AMF registration by Nudr_DM_Update.
19b. [Conditional] When the UDM stores the associated Access Type (i.e. non-3GPP) together with the serving AMF as indicated in step 19a, it will cause the UDM to initiate a Nudm_UECM_DeregistrationNotification (see clause 5.2.3.2.2) to the old AMF corresponding to the same (i.e. non-3GPP) access. The old AMF removes the UE context for non-3GPP access.
19c. The Old AMF unsubscribes with the UDM for subscription data using Nudm_SDM_unsubscribe.
20a. Void.
21. New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [NSAG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [AMF PEIPS Assistance Information], [Truncated 5G-S-TMSI Configuration], [Connection Release Supported], [Paging Cause Indication for Voice Service Supported], [Paging Restriction Supported], [Reject Paging Request Supported], [Paging Restriction Information acceptance/rejection], [“List of PLMN(s) to be used in Disaster Condition”], [Disaster Roaming wait range information], [Disaster Return wait range information]).

If the Requested NSSAI does not include S-NSSAIs which map to S-NSSAIS of the HPLMN subject to Network Slice-Specific Authentication and Authorization and the AMF determines that no S-NSSAI can be provided in the Allowed NSSAI for the UE in the current UE's Tracking Area and if no default S-NSSAI(s) not yet involved in the current UE Registration procedure could be further considered, the AMF shall reject the UE Registration and shall include in the rejection message the list of Rejected S-NSSAIs, each of them with the appropriate rejection cause value.

The Allowed NSSAI for the Access Type for the UE is included in the N2 message carrying the Registration Accept message. The Allowed NSSAI contains only S-NSSAIs that do not require, based on subscription information, Network Slice-Specific Authentication and Authorization and, based on the UE Context in the AMF, those S-NSSAIs for which Network Slice-Specific Authentication and Authorization previously succeeded, regardless of the Access Type. The Mapping Of Pending NSSAI is the mapping of each S-NSSAI of the Pending NSSAI for the Serving PLMN to the HPLMN S-NSSAIS.

If the UE has indicated its support of the Network Slice-Specific Authentication and Authorization procedure in the UE MM Core Network Capability in the Registration Request, AMF includes in the Pending NSSAI the S-NSSAIs that map to an S-NSSAI of the HPLMN which in the subscription information has indication that it is subject to Network Slice-Specific Authentication and Authorization, as described in clause 4.6.2.4 of TS 24.501 [25]. In such case, the AMF then shall trigger at step 25 the Network Slice-Specific Authentication and Authorization procedure, specified in clause 4.2.9.2, except, based on Network policies, for those S-NSSAIs for which Network Slice-Specific Authentication and Authorization have already been initiated on another Access Type for the same S-NSSAI(s). The UE shall not attempt re-registration with the S-NSSAIs included in the list of Pending NSSAIs until the Network Slice-Specific Authentication and Authorization procedure has been completed, regardless of the Access Type.

If the UE has not indicated its support of the Network Slice-Specific Authentication and Authorization procedure in the UE 5GMM Core Network Capability in the Registration Request and the Requested NSSAI includes S-NSSAIs which map to HPLMN S-NSSAIs subject to Network Slice-Specific Authentication and Authorization, the AMF includes those S-NSSAIs in the Requested NSSAI in the Rejected S-NSSAIS.

If no S-NSSAI can be provided in the Allowed NSSAI because:
all the S-NSSAI(s) in the Requested NSSAI are to be subject to Network Slice-Specific Authentication and Authorization; or
no Requested NSSAI was provided or none of the S-NSSAIs in the Requested NSSAI matches any of the Subscribed S-NSSAIs and all the S-NSSAI(s) marked as default in the Subscribed S-NSSAIs are to be subject to Network Slice-Specific Authentication and Authorization.

The AMF shall provide an empty Allowed NSSAI. Upon receiving an empty Allowed NSSAI and a Pending NSSAI, the UE is registered in the PLMN but shall wait for the completion of the Network Slice-Specific Authentication and Authorization procedure without attempting to use any service provided by the PLMN on any access, except e.g. emergency services (see TS 24.501 [25]), until the UE receives an Allowed NSSAI.

The AMF stores the NB-IoT Priority retrieved in Step 14 and associates it to the 5G-S-TMSI allocated to the UE.

If the Registration Request message received over 3GPP access does not include any Paging Restriction Information, the AMF shall delete any stored Paging Restriction Information for this UE and stop restricting paging accordingly.

If the Registration Request message received over 3GPP access includes the Paging Restriction Information, AMF may accept or reject the Paging Restriction Information requested by the UE based on operator policy. If the AMF rejects the Paging Restriction Information, the AMF removes any stored Paging Restriction Information from the UE context and discards the UE requested Paging Restriction Information. If the AMF accepts the Paging Restriction Information from the UE, the AMF stores the Paging Restriction Information from the UE in the UE context and informs the UE about the acceptance/rejection of the requested Paging Restriction Information in the Registration Accept message.

If the Registration Request message received over 3GPP access includes a Release Request indication, then:
the AMF updates the UE context with any received Paging Restriction Information, then enforces it in the network triggered Service Request procedure as described in clause 4.2.3.3;
the AMF does not establish User Plane resources and triggers the AN release procedure as described in clause 4.2.6 after the completion of Registration procedure.

The AMF sends a Registration Accept message to the UE indicating that the Registration Request has been accepted. 5G-GUTI is included if the AMF allocates a new 5G-GUTI. Upon receiving a Registration Request message of type “Initial Registration”, “mobility registration update”, “Disaster Roaming Initial Registration” or “Disaster Roaming Mobility Registration Update” from the UE, the AMF shall include a new 5G-GUTI in the Registration Accept message. Upon receiving a Registration Request message of type “periodic registration update” from the UE, the AMF should include a new 5G-GUTI in the Registration Accept message. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. For a Disaster Roaming Registration, the AMF allocates the Registration Area limited to the area with Disaster Condition as specified in clause 5.40 of TS 23.501 [2]. If there is no Registration area included in the Registration Accept message, the UE shall consider the old Registration Area as valid. Mobility Restrictions is included if mobility restrictions applies for the UE and Registration Type is not Emergency Registration. The AMF indicates the established PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE.

If the RAT Type is NB-IoT and the network is configured to use the Control Plane Relocation Indication procedure then the AMF shall include in the Registration Accept message the Truncated 5G-S-TMSI Configuration that the UE using Control Plane CIoT 5GS Optimisation uses to create the Truncated 5G-S-TMSI, see clause 5.31.4.3 of TS 23.501 [2].

The Allowed NSSAI provided in the Registration Accept is valid in the Registration Area and it applies for all the PLMNs which have their Tracking Areas included in the Registration Area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIS.

If the UE has indicated its support of the subscription-based restrictions to simultaneous registration of network slices feature in the UE 5GMM Core Network Capability, the AMF includes, if available, the NSSRG Information, defined in clause 5.15.12 of TS 23.501 [2].

If the UE has not indicated its support of the subscription-based restrictions to simultaneous registration of network slices feature and the subscription information for the UE includes SRG information and the AMF is providing the Configured NSSAI to the UE, the Configured NSSAI shall include the S-NSSAIS according to clause 5.15.12 of TS 23.501 [2].

If the UE has indicated its support of the NSAG feature in the 5GMM Core Network Capability, the AMF includes, if available, the NSAG Information, defined in clause 5.15.14 of TS 23.501 [2].

The AMF shall include in the Registration Accept message the LADN Information for the list of LADNs, described in clause 5.6.5 of TS 23.501 [2], that are available within the Registration area determined by the AMF for the UE. The AMF may include Operator-defined access category definitions to let the UE determine the applicable Operator-specific access category definitions as described in TS 24.501 [25].

If the UE included MICO mode in the Registration Request, then AMF responds in the Registration Accept message whether MICO mode should be used. When MICO mode is allowed for the UE, the AMF may include an Active Time value and/or Strictly Periodic Registration Timer Indication in the Registration Accept message. The AMF determines the Periodic Registration Update timer value, Active Time value and the Strictly Periodic Registration Timer Indication based on local configuration, Expected UE Behaviour if available, UE indicated preferences, UE capability, UE subscription information and network policies, or any combination of them so as to enable UE power saving, as described in clause 5.31.7 of TS 23.501 [2]. The AMF determines to apply the Strictly Periodic Registration Timer Indication to the UE if the UE indicates its capability of the Strictly Periodic Registration Timer Indication in the registration request message, as described in step 1. If the AMF provides the Periodic Registration Update timer value with the Strictly Periodic Registration Timer Indication to the UE, the UE and the AMF start the Periodic Registration Update timer after this step, as described in clause 5.31.7.5 of TS 23.501 [2].

In the case of registration over 3GPP access, the AMF Sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over 3GPP access and the AMF has retrieved or determined according to local configuration a Target NSSAI and a corresponding RFSP Index for the purpose of allowing the NG-RAN to redirect the UE to a cell supporting network slices not available in the current TA as described in clause 5.3.4.3.3 of TS 23.501 [2], the AMF provides the Target NSSAI and the corresponding RFSP Index for each TA in the TAI list to the NG-RAN.

In the case of registration over non-3GPP access, the AMF Sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. If the AMF received “MCX priority” from the UDM as part of Access and Mobility Subscription data, based on operator policy and UE subscription to MCX Services, “MCX priority” is included in the Registration Accept message to the UE to inform the UE whether configuration of Access Identity 2 is valid within the selected PLMN, as specified in TS 24.501 [25]. The Accepted DRX parameters are defined in clause 5.4.5 of TS 23.501 [2]. The AMF includes Accepted DRX parameters for NB-IoT, if the UE included Requested DRX parameters for NB-IoT in the Registration Request message. The AMF Sets the Network support of Interworking without N26 parameter as described in clause 5.17.2.3.1 of TS 23.501 [2]. If the AMF accepts the use of extended idle mode DRX, the AMF includes the extended idle mode DRX parameters and Paging Time Window as described in 5.31.7.2 of TS 23.501 [2].

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

The Access Stratum Connection Establishment NSSAI Inclusion Mode, as specified in clause 5.15.9 of TS 23.501 [2], is included to instruct the UE on what NSSAI, if any, to include in the Access Stratum connection establishment. The AMF can set the value to modes of operation a, b, c defined in clause 5.15.9 of TS 23.501 [2] in the 3GPP Access only if the Inclusion of NSSAI in RRC Connection Establishment Allowed indicates that it is allowed to do so.

For a UE registered in a PLMN, the AMF may provide a List of equivalent PLMNs which is handled as specified in TS 24.501 [25]. For a UE registered in an SNPN, the AMF shall not provide a list of equivalent PLMNs to the UE.

If the UE included support for restriction of use of Enhanced Coverage in step 1, the AMF sends the Enhanced Coverage Restricted information to the NG-RAN in N2 message. The AMF also sends Enhanced Coverage Restricted information to the UE in the Registration Accept message.

If the UE receives Enhanced Coverage Restricted information in the Registration Accept message, the UE shall store this information and shall use the value of Enhanced Coverage Restricted information to determine if Enhanced Coverage feature should be used or not.

If the UE and the AMF have negotiated to enable MICO mode and the AMF uses the Extended connected timer, then the AMF provides the Extended Connected time value to NG-RAN (see clause 5.31.7.3 of TS 23.501 [2]) in this step. The Extended Connected Time value indicates the minimum time the RAN should keep the UE in RRC-CONNECTED state regardless of inactivity.

The AMF indicates the CIoT 5GS Optimisations it supports and accepts in the Supported Network Behaviour information (see clause 5.31.2of TS 23.501 [2]) if the UE included Preferred Network Behaviour in its Registration Request.

The AMF may steer the UE from 5GC by rejecting the Registration Request. The AMF should take into account the Preferred and Supported Network Behaviour (see clause 5.31.2 of TS 23.501 [2]) and availability of EPC to the UE before steering the UE from 5GC.

If the AMF accepts MICO mode and knows there may be mobile terminated data or signalling pending, the AMF maintains the N2 connection for at least the Extended Connected Time as described in clause 5.31.7.3 of TS 23.501 [2] and provides the Extended Connected Time value to the RAN.

The AMF includes Service Gap Time if Service Gap Time is present in the subscription information (steps 14a-c) or the Service Gap Time has been updated by the Subscriber Data Update Notification to AMF procedure (see clause 4.5.1) and the UE has indicated UE Service Gap Control Capability.

If the UE receives a Service Gap Time in the Registration Accept message, the UE shall store this parameter and apply Service Gap Control (see clause 5.31.16 of TS 23.501 [2]).

If the network supports WUS grouping (see TS 23.501 [2]), the AMF shall send the WUS Assistance Information to the UE. If the UE provided the UE paging probability information in Step 1, the AMF takes it into account to determine the WUS Assistance Information.

If the UE provided Paging Subgrouping Support Indication in step 1, a supporting AMF may provide the AMF PEIPS Assistance Information, including the Paging Subgroup ID as defined in TS 23.501 [2].

When the UE and the AMF supports RACS as defined in clause 5.4.4.1a of TS 23.501 [2] and the AMF needs to configure the UE with a UE Radio Capability ID and the AMF already has the UE radio capabilities other than NB-IoT radio capabilities for the UE, the AMF may provide the UE with the UE Radio Capability ID for the UE radio capabilities the UCMF returns to the AMF in a Nucmf_assign service operation for this UE. Alternatively, when the UE and the AMF support RACS, the AMF may provide the UE with an indication to delete any PLMN-assigned UE Radio Capability ID in this PLMN (see clause 5.4.4.1a of TS 23.501 [2]).

If the UE is “CAG supported” and the AMF needs to update the CAG information of the UE, the AMF may include the CAG information as part of the Mobility Restrictions in the Registration Accept message.

If the Multi-USIM UE has indicated support for one or more Multi-USIM Specific Capabilities in the UE 5GMM Core Network Capability in step 1, the AMF shall indicate to the Multi-USIM UE whether the corresponding one or more Multi-USIM specific features described in clause 5.38 of TS 23.501 [2] are supported, based on network capability and preference by the network (i.e. based on local network policy), by providing one or more of the Connection Release Supported, Paging Cause Indication for Voice Service Supported, Paging Restriction Supported and Reject Paging Request Supported indications. The AMF shall only indicate Paging Restriction Supported together with either Connection Release Supported or Reject Paging Request Supported. The UE shall only use Multi-USIM specific features that the AMF indicated as being supported.

If the UE and AMF supports Disaster Roaming service, the AMF may include the “list of PLMN(s) to be used in Disaster Condition”, Disaster Roaming wait range information and Disaster Return wait range information as specified in TS 23.501 [2].

In the case of Emergency Registration, the AMF shall not indicate support for any Multi-USIM specific features to the UE.
21b. [Optional] The new AMF performs a UE Policy Association Establishment as defined in clause 4.16.11. For an Emergency Registration, this step is skipped.

The new AMF sends a Npcf_UEPolicy Control Create Request to PCF. PCF sends a Npcf_UEPolicyControl Create Response to the new AMF.

PCF triggers UE Configuration Update Procedure as defined in clause 4.2.4.3.
22. [Conditional] UE to new AMF: Registration Complete ( ).

The UE sends a Registration Complete message to the AMF when it has successfully updated itself after receiving any of the [Configured NSSAI for the Serving PLMN], [Mapping Of Configured NSSAI], [NSSRG Information], [NSAG Information] and a Network Slicing Subscription Change Indication, or CAG information in step 21.

The UE sends a Registration Complete message to the AMF to acknowledge if a new 5G-GUTI was assigned.

If new 5G-GUTI was assigned, then the UE passes the new 5G-GUTI to its 3GPP access' lower layer when a lower layer (either 3GPP access or non-3GPP access) indicates to the UE's RM layer that the Registration Complete message has been successfully transferred across the radio interface.

NOTE 13: The above is needed because the NG-RAN may use the RRC Inactive state and a part of the 5G-GUTI is used to calculate the Paging Frame (see TS 38.304 [44] and TS 36.304 [43]). It is assumed that the Registration Complete is reliably delivered to the AMF after the 5G-AN has acknowledged its receipt to the UE.

When the List Of PDU Sessions To Be Activated is not included in the Registration Request and the Registration procedure was not initiated in CM-CONNECTED state, the AMF releases the signalling connection with UE, according to clause 4.2.6.

When the Follow-on request is included in the Registration Request, the AMF should not release the signalling connection after the completion of the Registration procedure.

If the AMF is aware that some signalling is pending in the AMF or between the UE and the 5GC, the AMF should not release the signalling connection immediately after the completion of the Registration procedure.

If PLMN-assigned UE Radio Capability ID is included in step 21, the AMF stores the PLMN-assigned UE Radio Capability ID in UE context if receiving Registration Complete message.

If the UE receives PLMN-assigned UE Radio Capability ID deletion indication in step 21, the UE shall delete the PLMN-assigned UE Radio Capability ID(s) for this PLMN.
23. [Conditional] AMF to UDM: If the Access and Mobility Subscription data provided by UDM to AMF in 14b includes Steering of Roaming information with an indication that the UDM requests an acknowledgement of the reception of this information from the UE, the AMF provides the UE acknowledgement to UDM using Nudm_SDM_Info. For more details regarding the handling of Steering of Roaming information refer to TS 23.122 [22].
23a. For Registration over 3GPP Access, if the AMF does not release the signalling connection, the AMF sends the RRC Inactive Assistance Information to the NG-RAN.

For Registration over non-3GPP Access, if the UE is also in CM-CONNECTED state on 3GPP access, the AMF sends the RRC Inactive Assistance Information to the NG-RAN. If the Multi-USIM UE has indicated support for the Paging Cause Indication for Voice Service feature and the network supports the Paging Cause Indication for Voice Service, the AMF shall include an indication in the RRC Inactive Assistance Information that the UE supports the Paging Cause Indication for Voice Service to NG-RAN to enable NG-RAN to apply the Paging Cause Indication for Voice Service feature for RAN based paging.

The AMF also uses the Nudm_SDM_Info service operation to provide an acknowledgment to UDM that the UE received CAG information, or the Network Slicing Subscription Change Indication (see step 21 and step 22) and acted upon it.
24. [Conditional] AMF to UDM: After step 14a and in parallel to any of the preceding steps, the AMF shall send a “Homogeneous Support of IMS Voice over PS Sessions” indication to the UDM using Nudm_UECM_Update:

If the AMF has evaluated the support of IMS Voice over PS Sessions, see clause 5.16.3.2 of TS 23.501 [2], and
If the AMF determines that it needs to update the Homogeneous Support of IMS Voice over PS Sessions, see clause 5.16.3.3 of TS 23.501 [2].
25. [Conditional] If the UE indicates its support for Network Slice-Specific Authentication and Authorization procedure in the UE MM Core Network Capability in Registration Request and any S-NSSAI of the HPLMN is subject to Network Slice-Specific Authentication and Authorization, the related procedure is executed at this step (see clause 4.2.9.1). Once the Network Slice-Specific Authentication and Authorization procedure is completed for all S-NSSAIs, the AMF shall trigger a UE Configuration Update procedure to deliver an Allowed NSSAI containing also the S-NSSAIs for which the Network Slice-Specific Authentication and Authorization was successful and include any rejected NSSAIs with an appropriate rejection cause value.

The AMF shall remove the mobility restriction if the Tracking Areas of the Registration Area were previously assigned as a Non-Allowed Area due to pending Network Slice-Specific Authentication and Authorization.

The AMF stores an indication in the UE context for any S-NSSAI of the HPLMN subject to Network Slice-Specific Authentication and Authorization for which the Network Slice-Specific Authentication and Authorization succeeds.

Once completed the Network Slice-Specific Authentication and Authorization procedure, if the AMF determines that no S-NSSAI can be provided in the Allowed NSSAI for the UE, which is already authenticated and authorized successfully by a PLMN and if no default S-NSSAI(s) could be further considered, the AMF shall execute the Network-initiated Deregistration procedure described in clause 4.2.2.3.3 and shall include in the explicit De-Registration Request message the list of Rejected S-NSSAIs, each of them with the appropriate rejection cause value.

The mobility related event notifications towards the NF consumers are triggered at the end of this procedure for cases as described in clause 4.15.4.

### 4.2.4.2 UE Configuration Update Procedure for Access and Mobility Management Related Parameters

FIG. 20 is a UE Configuration Update procedure for access and mobility management related parameters.

This procedure is initiated by the AMF when the AMF wants to update access and mobility management related parameters in the UE configuration.

This procedure is also used to trigger UE to perform, based on network indication, either Mobility Registration Update procedure while the UE is in CM-CONNECTED state to modify NAS parameters that require negotiation (e.g. MICO mode) or to steer the UE towards EPC as specified in clause 5.31.3 of TS 23.501 [2], or Mobility Registration Update procedure after the UE enters CM-IDLE state (e.g. for changes to Allowed NSSAI that require re-registration). If a Registration procedure is needed, the AMF provides an indication to the UE to initiate a Registration procedure.

UE Configuration Update shall be sent over the Access Type (i.e. 3GPP access or non-3GPP access) the UE Configuration Update is applied to, when applicable. If the AMF wants to update NAS parameters in the UE which require UE acknowledgement, then the AMF provides an indication to the UE of whether the UE shall acknowledge the command or not. The AMF should not request acknowledgement of the NITZ command. The AMF shall request acknowledgement for NSSAI information (e.g. Allowed NSSAI), 5G-GUTI, TAI List and Mobility Restrictions, LADN Information, MICO, Operator-defined access category definitions, PLMN-assigned UE Radio Capability ID and SMS subscription.
0. AMF determines the necessity of UE configuration change due to various reasons (e.g. UE mobility change, NW policy, reception of Subscriber Data Update Notification from UDM, change of Network Slice configuration (including due to change of the NSSRG information in subscription information as specified in clause 5.15.12 of TS 23.501 [2], or due to change of NSAG Information as specified in clause 5.15.14 of TS 23.501 [2]), need to assign PLMN-assigned UE Radio Capability ID, change of Enhanced Coverage Restriction information in the UE context) or that the UE needs to perform a Registration Procedure. If a UE is in CM-IDLE, the AMF can wait until the UE is in CM-CONNECTED state or triggers Network Triggered Service Request (in clause 4.2.3.3).

NOTE 1: It is up to the network implementation whether the AMF can wait until the UE is in CM-CONNECTED state or trigger the Network Triggered Service Request.

NOTE 2: The AMF can check whether Network Slice configuration needs to be updated by using the Nnssf_NSSelection_Get service operation and in such case the AMF compares the stored information with the output from the NSSF to decide whether an update of the UE is required.

The AMF may include Mobility Restriction List in N2 message that delivers UE Configuration Update Command to the UE if the service area restriction for the UE is updated.
1. The AMF sends UE Configuration Update Command containing one or more UE parameters (Configuration Update Indication, 5G-GUTI, TAI List, Allowed NSSAI, Mapping Of Allowed NSSAI, Configured NSSAI for the Serving PLMN, Mapping Of Configured NSSAI, [NSSRG Information], rejected S-NSSAIs, NITZ, Mobility Restrictions, LADN Information, MICO, Operator-defined access category definitions, SMS Subscribed Indication, [PLMN-assigned UE Radio Capability ID], [PLMN-assigned UE Radio Capability ID deletion indication], [“List of PLMN(s) to be used in Disaster Condition”], [Disaster Roaming wait range information], [Disaster Return wait range information], [MPS priority]) to the UE. Optionally, the AMF may update the rejected S-NSSAIs in the UE Configuration Update command.

The AMF includes one or more of 5G-GUTI, TAI List, Allowed NSSAI, Mapping Of Allowed NSSAI, Configured NSSAI for the Serving PLMN, Mapping Of Configured NSSAI, rejected S-NSSAIs, NITZ (Network Identity and Time Zone), Mobility Restrictions parameters, LADN Information, Operator-defined access category definitions, PLMN-assigned UE Radio Capability ID, or SMS Subscribed Indication if the AMF wants to update these NAS parameters without triggering a UE Registration procedure.

The AMF may include in the UE Configuration Update Command also Configuration Update Indication parameters indicating whether:
Network Slicing Subscription Change has occurred;
the UE shall acknowledge the command; and
whether a Registration procedure is requested.

If the AMF indicates Network Slicing Subscription Change, then the UE shall locally erase all the network slicing configuration for all PLMNs and, if applicable, update the configuration for the current PLMN based on any received information. If the AMF indicates Network Slicing Subscription Change, the UE shall also be requested to acknowledge in step 2.

If the AMF also includes in the UE Configuration Update Command message a new Configured NSSAI for the Serving PLMN, then the AMF should also include a new Allowed NSSAI with, if available, the associated Mapping Of Allowed NSSAI, unless the AMF cannot determine the new Allowed NSSAI after the Subscribed S-NSSAI(s) are updated, in which case the AMF does not include in the UE Configuration Update Command message any Allowed NSSAI. If the UE has indicated its support of the subscription-based restrictions to simultaneous registration of network slices feature in the UE 5GMM Core Network Capability, the AMF includes, if available, the NSSRG Information, defined in clause 5.15.12 of TS 23.501 [2]. If the UE has not indicated its support of the subscription-based restrictions to simultaneous registration of network slices feature and the subscription information for the UE includes NSSRG information and the AMF is providing the Configured NSSAI to the UE, the Configured NSSAI shall include the S-NSSAIs according to clause 5.15.12 of TS 23.[2].

If the UE has indicated its support of NSAG feature in 5GMM Core Network Capability, the AMF includes, if available, the NSAG Information, defined in clause 5.15.14 of TS 23.501 [2] when providing a new Configured NSSAI which includes S-NSSAIs with associated NSAG Value(s) or when the NSAG Information changes for some S-NSSAI in the Configured NSSAI. When NSAG Information is provided to the UE, the AMF requests the UE to acknowledge the UE Configuration Command message.

When the UE and the AMF supports RACS as defined in clause 5.4.4.1a of TS 23.501 [2] and the AMF needs to configure the UE with a UE Radio Capability ID and the AMF already has the UE radio capabilities other than NB-IoT radio capabilities for the UE and, the AMF may provide the UE with the UE Radio Capability ID for the UE radio capabilities the UCMF returns to the AMF in a Nucmf_assign service operation for this UE.

If the UE is needed to be redirected to the dedicated frequency band(s) for S-NSSAI(s), the AMF may determine a Target NSSAI for each TA in the TAI list, as described in clause 5.3.4.3.3 of TS 23.501 [2], itself or by interacting with the NSSF using Nnssf_NSSelection_Get which includes e.g. the Rejected S-NSSAI(s) for RA and Allowed NSSAI. The AMF may determine RFSP index associated to the Target NSSAI by interacting with the PCF using Npcf_AMPolicyControl_Update which includes the Target NSSAI to retrieve a corresponding RFSP index or based on local configuration in case PCF is not deployed. The Target NSSAI and the RFSP index associated with the Target NSSAI for each TA in the TAI list are provided to the NG-RAN within the N2 message carrying the UE Configuration Update Command message.

If the UE and AMF supports Disaster Roaming service, the AMF may include the “list of PLMN(s) to be used in Disaster Condition”, Disaster Roaming wait range information and Disaster Return wait range information as specified in TS 23.501 [2].
2a. If the UE Configuration Update Indication requires acknowledgement of the UE Configuration Update Command, then the UE shall send a UE Configuration Update complete message to the AMF. The AMF should request acknowledgement for all UE Configuration Updates, except when only NITZ is provided. If Registration procedure is not required, steps 3a, 3b, 3c and step 4 are skipped. If the Configuration Update Indication is included in the UE Configuration Update Command message and it requires a Registration procedure, depending on the other NAS parameters included in the UE Configuration Update command, the UE shall execute steps 3a or 3b or 3c+4 as applicable.

If the PLMN-assigned UE Radio Capability ID is included in step 1, the AMF stores the UE Radio Capability ID in UE context if receiving UE Configuration Update complete message.

If the UE receives PLMN-assigned UE Radio Capability ID deletion indication in step 1, the UE shall delete the PLMN-assigned UE Radio Capability ID(s) for this PLMN. If UE Configuration Update is only for this purpose, the following steps are skipped.
2b. [Conditional] The AMF also uses the Nudm_SDM_Info service operation to provide an acknowledgment to UDM that the UE received CAG information as part of the Mobility Restrictions (if the CAG information was updated), or the Network Slicing Subscription Change Indication (if this was indicated in step 1) and acted upon it.
2c. [Conditional] If the AMF has reconfigured the 5G-GUTI over 3GPP access, the AMF informs the NG-RAN of the new UE Identity Index Value (derived from the new 5G-GUTI) when the AMF receives the acknowledgement from the UE in step 2a.

[Conditional] If the UE is registered to the same PLMN via both 3GPP and non-3GPP access and if the AMF has reconfigured the 5G-GUTI over non-3GPP access and the UE is in CM-CONNECTED state over 3GPP access, then the AMF informs the NG-RAN of the new UE Identity Index Value (derived from the new 5G-GUTI) when the AMF receives the acknowledgement from the UE in step 2a.

[Conditional] If the AMF has configured the UE with a PLMN-assigned UE Radio Capability ID, the AMF informs NG-RAN of the UE Radio Capability ID, when it receives the acknowledgement from the UE in step 2a.

[Conditional] If the Mobility Restrictions for the UE were updated and the Mobility Restrictions were not provided in the N2 message that delivers the UE Configuration Update Command, the AMF provides the NG-RAN with updated Mobility Restrictions unless the AMF releases the UE in this step (see below).

If the AMF initiated the UE Configuration Update procedure due to receiving Nudm_SDM_Notification and the CAG information has changed such that a CAG Identifier has been removed from the Allowed CAG list or the UE is only allowed to access CAG cells, the AMF shall release the NAS signalling connection by triggering the AN Release procedure for UEs that are not receiving Emergency Services as defined in TS 23.501 [2].

NOTE 3: When the UE is accessing the network for emergency service the conditions in clause 5.16.4.3 of TS 23.501 [2] apply.
2d [Conditional] If the UE is configured with a new 5G-GUTI in step 2a via non-3GPP access and the UE is registered to the same PLMN via both 3GPP and non-3GPP access, then the UE passes the new 5G-GUTI to its 3GPP access' lower layers.

If the UE is configured with a new 5G-GUTI in step 2a over the 3GPP access, the UE passes the new 5G-GUTI to its 3GPP access' lower layers.

NOTE 4: Steps 2c and 2d are needed because the NG-RAN may use the RRC Inactive state and a part of the 5G-GUTI is used to calculate the Paging Frame (see TS 38.304 [44] and TS 36.304 [43]). It is assumed that the UE Configuration Update Complete is reliably delivered to the AMF after the 5G-AN has acknowledged its receipt to the UE.
3a. [Conditional] If only NAS parameters that can be updated without transition from CM-IDLE are included (e.g. MICO mode, Enhanced Coverage Restricted information) the UE shall initiate a Registration procedure immediately after the acknowledgement to re-negotiate the updated NAS parameter(s) with the network. Steps 3b, 3c and step 4 are skipped.
3b [Conditional] If a new Allowed NSSAI and/or a new Mapping Of Allowed NSSAI and/or a new Configured NSSAI provided by the AMF to the UE in step 1 does not affect the existing connectivity to AMF, the AMF needs not release the NAS signalling connection for the UE after receiving the acknowledgement in step 2 and immediate registration is not required. The UE can start immediately using the new Allowed NSSAI and/or the new Mapping Of Allowed NSSAI. If one or more PDU Sessions use a S-NSSAI that is not part of the new Allowed NSSAI, the AMF indicates to the SMF(s) the corresponding PDU Session ID(s) and each SMF releases the PDU Session(s) according to clause 4.3.4.2. The UE cannot connect to an S-NSSAI included in the new Configured NSSAI for the Serving PLMN but not included in the new Allowed NSSAI until the UE performs a Registration procedure and includes a Requested NSSAI based on the new Configured NSSAI, following the requirements described in clause 5.15.5.2 of TS 23.501 [2]. Steps 3c and 4 are skipped.

The AMF may, based on its policy, provide anyway an indication that a Registration procedure is required even though the UE Configuration Update Command in step 1 does not affect the existing connectivity to Network Slices: in such a case only step 3c is skipped.
3c. [Conditional] If a new Allowed NSSAI and/or a new Mapping Of Allowed NSSAI and/or a new Configured NSSAI provided by the AMF to the UE in step 1 affects ongoing existing connectivity to AMF, then the AMF shall provide an indication that the UE shall initiate a Registration procedure.
4. [Conditional] After receiving the acknowledgement in step 2, the AMF shall release the NAS signalling connection for the UE by triggering the AN Release procedure, unless there is one established PDU Sessions associated with regulatory prioritized services. If there is one established PDU Session associated with regulatory prioritized services, the AMF informs SMFs to release the PDU Session(s) associated with non regulatory prioritized services for this UE (see clause 4.3.4).

The AMF shall reject any NAS Message from the UE carrying PDU Session Establishment Request for a non-emergency PDU Session before the required Registration procedure has been successfully completed by the UE.

The UE initiates a Registration procedure (see clauses 4.2.2.2.2 and 4.13.3.1) with registration type Mobility Registration Update after the UE enters CM-IDLE state and shall not include the 5G-S-TMSI or GUAMI in Access Stratum signalling and shall include, subject to the conditions set out in clause 5.15.9 of TS 23.501 [2], a Requested NSSAI in access stratum signalling. If there is an established PDU Session associated with emergency service and the UE has received an indication to perform the Registration procedure, the UE shall initiate the Registration procedure only after the PDU Session associated with emergency service is released.

NOTE 5: Receiving UE Configuration Update command without an indication requesting to perform re-registration, can still trigger Registration procedure by the UE for other reasons.

### 5.2.5.2.2 Npcf_AMPolicy Control_Create Service Operation

Service Operation name: Npcf_AMPolicy Control_Create

Description: NF Service Consumer can request the creation of an AM Policy Association and by providing relevant parameters about the UE context to the PCF.

Inputs, Required: SUPI.

Inputs, Optional: Information provided by the AMF, such as Access Type, Permanent Equipment Identifier, GPSI, User Location Information, UE Time Zone, Serving Network identifier (PLMN ID, or PLMN ID and NID, see clause 5.34 of TS 23.501 [2]), RAT type, List of subscribed Service Area Restrictions, subscribed RFSP Index, the Allowed NSSAI, Target NSSAIs with TAI, GUAMI, Subscribed UE-AMBR, Internal Group (see clause 5.9.7 of TS 23.501 [2]), subscription notification indication, backup AMF(s) (if NF Type is AMF). Backup AMF(s) are sent only once by the AMF to the PCF in its first interaction with the PCF, list of NWDAF instance Ids and corresponding Analytics ID(s).

Outputs, Required: AM Policy Association ID.

Outputs, Optional: The requested access and mobility related policy information as defined in clause 6.5 of TS 23.503 [20] and Policy Control Request Trigger(s) of AM Policy Association as defined in clause 6.1.2.5 of TS 23.503 [20].

See clause 4.2.2.2.2 (step 16) for the detail usage of this service operation for AMF. In step 16, the AMF requests the PCF to apply operator policies for the UE.

See clause 4.16.1.2 (steps 2 and 3) for the detail usage of this service operation for AMF. In step 2, the AMF requests the PCF to apply operator policies for the UE; in step 3, the PCF acknowledges AMF with requested policy.

### 5.2.16.2.1 Nnssf_NSSelection_Get Service Operation

### Service Operation Name: Nnssf_NSSelection Get

Description: This service operation enables Network Slice selection in both the Serving PLMN and HPLMN. It also enables the NSSF to provide to the AMF the Allowed NSSAI and the Configured NSSAI for the Serving PLMN. It allows also to provide the NSAG information which is applicable (clause 5.15.14 of TS 23.501 [2]).

It may be invoked during Registration procedure, during inter-PLMN mobility procedure, during PDU Session Establishment procedure or during UE Configuration Update procedure. When invoked during Registration procedure it may possibly trigger AMF re-allocation. When invoked during PDU Session Establishment procedure it may be invoked in the VPLMN or in the HPLMN; if invoked in the VPLMN it returns the hNRF selected by the hNSSF and, if applicable, the value of the HPLMN NSI ID. When invoked during UE Configuration Update procedure or inter-PLMN mobility procedure it may be invoked in the Serving PLMN.

NOTE 1: The list of events, which trigger invoking of the Nnssf_NSSelection_Get service operation, is not exhaustive.

NOTE 2: The NSSF can determine the serving network and Access Type from the TAI, as described in TS 29.571 [70].

Inputs, Required: None.

### Inputs, Conditional Required:

If this service operation is invoked during Registration procedure for Network Slice selection or UE Configuration Update procedure, then the following inputs are required:
Subscribed S-NSSAI(s) with the indication if marked as default S-NSSAI, PLMN ID of the SUPI, TAI, NF type of the NF service consumer, Requester ID.

If this service operation is invoked to derive the S-NSSAI for the serving PLMN (as described in clause 4.11.1.3.3), the following inputs are required:
S-NSSAIs for the HPLMN associated with established PDN connection, PLMN ID of the SUPI, NF type of the NF service consumer, Requester ID.

If this service operation is invoked by target AMF during inter-PLMN mobility procedure, the following inputs are required:
S-NSSAIs for the HPLMN, PLMN ID of the SUPI, TAI.

If this service operation is invoked during PDN Connection Establishment in the Serving PLMN in EPS by a SMF+PGW-C, the following inputs are required:
Subscribed S-NSSAIs for the UE, PLMN ID of the SUPI, NF type of the NF service consumer, Requester ID.

If this service operation is invoked during PDU Session Establishment procedure in the Serving PLMN then the following inputs are required:
S-NSSAI, non-roaming/LBO roaming/HR roaming indication, PLMN ID of the SUPI, TAI, NF type of the NF service consumer, Requester ID.

### Inputs, Optional:

If this service operation is invoked during Registration procedure for Network Slice selection or UE Configuration Update procedure, then the following inputs are provided if available:
Requested NSSAI, Mapping Of Requested NSSAI, Default Configured NSSAI Indication, NSSRG Information, UE support of subscription-based restrictions to simultaneous registration of network slice feature Indication, UDM indication to provide all subscribed S-NSSAIs for UEs not indicating support of subscription-based restrictions to simultaneous registration of network slices, Allowed NSSAI for current Access Type, Allowed NSSAI for the other Access Type and the corresponding Mapping Of Allowed NSSAIs for current Access Type and other Access Type, Rejected S-NSSAI(s) for RA, UE support of NSAG Information, A list of TAIs.

If this service operation is invoked during PDU Session Establishment procedure, then the following input is optional:
HPLMN S-NSSAI that maps to the S-NSSAI from the Allowed NSSAI of the Serving PLMN.

### Outputs, Conditional Required:

If this service operation is invoked during Registration procedure for Network Slice selection or UE Configuration Update procedure, then one or more of the following outputs are required:
Allowed NSSAI, Configured NSSAI; Target AMF Set or, based on configuration, the list of candidate AMF(s).

If this service operation is invoked during inter-PLMN mobility procedure, then one or more of the following outputs are required:
Allowed NSSAI.

If this service operation is invoked to derive the S-NSSAI for the serving PLMN (as described in clause 4.11.1.3.3), the following output is required:
S-NSSAIs for the HPLMN associated with established PDN connection, Mapping of S-NSSAIs associated with established PDN connection in the Serving PLMN.

If this service operation is invoked during PDN Connection Establishment in the Serving PLMN in EPS by a SMF+PGW-C, the following outputs are required:
Subscribed S-NSSAIs for the UE, Mapping of S-NSSAIs associated with the subscribed S-NSSAIs for the UE in the Serving PLMN.

If this service operation is invoked during PDU Session Establishment procedure, then the following outputs are required:
The NRF to be used to select NFs/services within the selected Network Slice instance.
   Outputs, conditional Optional:

If this service operation is invoked during UE Registration procedure or UE Configuration Update procedure, then one or more of the following outputs are optional:
Mapping Of Allowed NSSAI, Mapping Of Configured NSSAI, NSI ID(s) associated with the Network Slice instances of the Allowed NSSAI, NRF(s) to be used to select NFs/services within the selected Network Slice instance(s) and NRF to be used to determine the list of candidate AMF(s) from the AMF Set, rejected S-NSSAI with cause of rejection, Target NSSAIs per TAI, the NSAG information (defined in clause 5.15.14 of TS 23.501 [2]).

If this service operation is invoked during inter-PLMN mobility procedure, then the following output is optional:
Mapping Of Allowed NSSAI.

If this service operation is invoked during PDU Session Establishment procedure, then the following output is optional:
NSI ID associated with the S-NSSAI provided in the input.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### SUPPLEMENTARY NOTES

The whole or part of the example Aspects disclosed above can be described as, but not limited to, the following supplementary notes.
supplementary note 1. A method of a User Equipment (UE), the method comprising:
   receiving Target Network Slice Selection Assistance Information (NSSAI); and
   performing a cell selection or a cell reselection based on the Target NSSAI.
supplementary note 2. The method according to supplementary note 1,
   wherein the Target NSSAI is included in a Registration Accept message.
supplementary note 3. The method according to supplementary note 1 or 2,
   wherein the performing the cell selection or the cell reselection includes selecting or reselecting a cell which supports Single Network Slice Selection Assistance Information (S-NSSAI) in the Target NSSAI.
supplementary note 4. The method according to supplementary note 3, further comprising:
   sending a Registration Request message,
   wherein the Registration Request message includes Requested NSSAI, and
   wherein the Requested NSSAI includes the S-NSSAI.
supplementary note 5. The method according to any one of supplementary notes 1 to 4, further comprising:
   sending information indicating the UE supports the Target NSSAI.
supplementary note 6. The method according to supplementary note 5,
   wherein the receiving the Target NSSAI includes receiving the Target NSSAI in a case of sending the information indicating the UE supports the Target NSSAI.
supplementary note 7. A method of a communication apparatus, the method comprising:
   sending target network slice selection assistance information (NSSAI) to a User Equipment (UE); and
   receiving a Registration Request message from the UE,
   wherein the Registration Request message includes Requested NSSAI, and
   wherein the Requested NSSAI includes Single Network Slice Selection Assistance Information (S-NSSAI), and
   wherein the S-NSSAI is included in the Target NSSAI.
supplementary note 8. The method according to supplementary note 7,
   wherein the Target NSSAI is included in a Registration Accept message.
supplementary note 9. The method according to supplementary note 7 or 8, further comprising:
   receiving information indicating the UE supports the Target NSSAI.
supplementary note 10. The method according to supplementary note 9 ,
   wherein the sending the Target NSSAI includes sending the Target NSSAI in a case of receiving the information indicating the UE supports the Target NSSAI.
supplementary note 11. A method of a User Equipment (UE), the method comprising:
   receiving Target Network Slice Selection Assistance Information (NSSAI) during Protocol Data Unit (PDU) session establishment procedure or service request procedure; and
   performing a cell selection or a cell reselection based on the Target NSSAI.
supplementary note 12. The method according to supplementary note 11,
   wherein the Target NSSAI is included in a Non Access Stratum (NAS) message.
supplementary note 13. The method according to supplementary note 11 or 12,
   wherein the performing the cell selection or the cell reselection includes selecting or reselecting a cell which supports Single Network Slice Selection Assistance Information (S-NSSAI) in the Target NSSAI.
supplementary note 14. The method according to supplementary note 13, further comprising:
   sending a Registration Request message,
   wherein the Registration Request message includes Requested NSSAI, and
   wherein the Requested NSSAI includes the S-NSSAI.
supplementary note 15. The method according to supplementary note 13 or 14, further comprising:
   performing PDU session modification procedure for the S-NSSAI.
supplementary note 16. The method according to any one of supplementary notes 11 to 15, further comprising:
   sending information indicating the UE supports the Target NSSAI.
supplementary note 17. The method according to supplementary note 16,
   wherein the receiving the Target NSSAI includes receiving the Target NSSAI in a case of sending the information indicating the UE supports the Target NSSAI.
supplementary note 18. A method of a communication apparatus, the method comprising:
   receiving a message from a User Equipment (UE) during Protocol Data Unit (PDU) session establishment procedure or service request procedure; and
   sending Target Network Slice Selection Assistance Information (NSSAI) during the PDU session establishment procedure or the service request procedure.
supplementary note 19. The method according to supplementary note 18,
   wherein the Target NSSAI is included in a Non Access Stratum (NAS) message.
supplementary note 20. The method according to supplementary note 18 or 19, further comprising:
   receiving a Registration Request message,
   wherein the Registration Request message includes Requested NSSAI,
   wherein the Requested NSSAI includes Single Network Slice Selection Assistance Information (S-NSSAI), and
   wherein the S-NSSAI is included in the Target NSSAI.
supplementary note 21. The method according to supplementary note 20, further comprising:
   performing PDU session modification procedure for the S-NSSAI.
supplementary note 22. The method according to any one of supplementary notes 18 to 21, further comprising:
   receiving information indicating the UE supports the Target NSSAI.
supplementary note 23. The method according to supplementary note 22,
   wherein the sending the Target NSSAI includes sending the Target NSSAI in a case of receiving the information indicating the UE supports the Target NSSAI.
supplementary note 24. A method of a User Equipment (UE), the method comprising:
   receiving a Radio Resource Control (RRC) message,
   wherein the RRC message includes Target Network Slice Selection Assistance Information (NSSAI); and
   sending a Registration Request message,
   wherein the Registration Request message includes Requested NSSAI,
   wherein the Requested NSSAI includes Single Network Slice Selection Assistance Information (S-NSSAI), and
   wherein the S-NSSAI is included in the Target NSSAI.
supplementary note 25. The method according to supplementary note 24,
   wherein the RRC message is an RRC Release message.
supplementary note 26. The method according to supplementary note 24 or 25, further comprising:
   sending information indicating the UE supports the Target NSSAI.
supplementary note 27. The method according to supplementary note 26,
   wherein the receiving the Target NSSAI includes receiving the Target NSSAI in a case of sending the information indicating the UE supports the Target NSSAI.
supplementary note 28. A method of a communication apparatus, the method comprising:
   receiving Target Network Slice Selection Assistance Information (NSSAI); and
   sending a Radio Resource Control (RRC) message to a User Equipment (UE),
   wherein the RRC message includes the Target NSSAI.
supplementary note 29. The method according to supplementary note 28,
   wherein the RRC message is an RRC Release message.
supplementary note 30. The method according to supplementary note 28 or 29,
   wherein the receiving the Target NSSAI includes receiving the Target NSSAI in a case where the UE supports the Target NSSAI.
supplementary note 31. A method of a first communication apparatus, the method comprising:
   communicating with a second communication apparatus; and
   sending Target Network Slice Selection Assistance Information (NSSAI) for a list of a Tracking Area (TA).
supplementary note 32. The method according to supplementary note 31,
   wherein the list of the TA is assigned to a User Equipment (UE).
supplementary note 33. The method according to supplementary note 32,
   wherein the list of the TA includes a first TA where the UE locates and a second TA where the UE does not locate.
supplementary note 34. The method according to any one of supplementary notes 31 to 33, further comprising:
   receiving the list of the TA.
supplementary note 35. The method according to supplementary note 34,
   wherein the list of the TA is included in a NG SETUP REQUEST message.
supplementary note 36. The method according to any one of supplementary notes 31 to 35,
   wherein the Target NSSAI is included in a NG SETUP RESPONSE message.
supplementary note 37. The method according to any one of supplementary notes 31 to 35,
   wherein the Target NSSAI is included in an AMF CONFIGURATION UPDATE message.
supplementary note 38. A method of a first communication apparatus, the method comprising:
   communicating with a second communication apparatus; and
   receiving Target Network Slice Selection Assistance Information (NSSAI) for a list of a Tracking Area (TA).
supplementary note 39. The method according to supplementary note 38,
   wherein the list of the TA is assigned to a User Equipment (UE).
supplementary note 40. The method according to supplementary note 39,
   wherein the list of the TA includes a first TA where the UE locates and a second TA where the UE does not locate.
supplementary note 41. The method according to any one of supplementary notes 38 to 40, further comprising:
   sending the list of the TA.
supplementary note 42. The method according to supplementary note 41,
   wherein the list of the TA is included in a NG SETUP REQUEST message.
supplementary note 43. The method according to any one of supplementary notes 38 to 42,
   wherein the Target NSSAI is included in a NG SETUP RESPONSE message.
supplementary note 44. The method according to any one of supplementary notes 38 to 42,
   wherein the Target NSSAI is included in an AMF CONFIGURATION UPDATE message.
supplementary note 45. A User Equipment (UE) comprising:
   means for receiving Target Network Slice Selection Assistance Information (NSSAI); and
   means for performing a cell selection or a cell reselection based on the Target NSSAI.
supplementary note 46. The UE according to supplementary note 45,
   wherein the Target NSSAI is included in a Registration Accept message.
supplementary note 47. The UE according to supplementary note 45 or 46, further comprising:
   means for selecting or reselecting a cell which supports Single Network Slice Selection Assistance Information (S-NSSAI) in the Target NSSAI.
supplementary note 48. The UE according to supplementary note 47, further comprising:
   means for sending a Registration Request message,
   wherein the Registration Request message includes Requested NSSAI, and
   wherein the Requested NSSAI includes the S-NSSAI.
supplementary note 49. The UE according to any one of supplementary notes 45 to 48, further comprising:
   means for sending information indicating the UE supports the Target NSSAI.
supplementary note 50. The UE according to supplementary note 49, further comprising:
   means for receiving the Target NSSAI in a case of sending the information indicating the UE supports the Target NSSAI.
supplementary note 51. A communication apparatus comprising:
   means for sending Target Network Slice Selection Assistance Information (NSSAI) to a User Equipment (UE); and
   means for receiving a Registration Request message from the UE,
   wherein the Registration Request message includes Requested NSSAI, and
   wherein the Requested NSSAI includes Single Network Slice Selection Assistance Information (S-NSSAI), and
   wherein the S-NSSAI is included in the Target NSSAI.
supplementary note 52. The communication apparatus according to supplementary note 51,
   wherein the Target NSSAI is included in a Registration Accept message.
supplementary note 53. The communication apparatus according to supplementary note 51 or 52, further comprising:
   means for receiving information indicating the UE supports the Target NSSAI.
supplementary note 54. The communication apparatus according to supplementary note 53, further comprising:
   means for sending the Target NSSAI in a case of receiving the information indicating the UE supports the Target NSSAI.
supplementary note 55. A User Equipment (UE) comprising:
   means for receiving Target Network Slice Selection Assistance Information (NSSAI) during Protocol Data Unit (PDU) session establishment procedure or service request procedure; and
   means for performing a cell selection or a cell reselection based on the Target NSSAI.
supplementary note 56. The UE according to supplementary note 55,
   wherein the Target NSSAI is included in a Non Access Stratum (NAS) message.
supplementary note 57. The UE according to supplementary note 55 or 56, further comprising:
   means for selecting or reselecting a cell which supports Single Network Slice Selection Assistance Information (S-NSSAI) in the Target NSSAI.
supplementary note 58. The UE according to supplementary note 57, further comprising:
   means for sending a Registration Request message,
   wherein the Registration Request message includes Requested NSSAI, and
   wherein the Requested NSSAI includes the S-NSSAI.
supplementary note 59. The UE according to supplementary note 57 or 58, further comprising:
   means for performing PDU session modification procedure for the S-NSSAI.
supplementary note 60. The UE according to any one of supplementary notes 55 to 59, further comprising:
   means for sending information indicating the UE supports the Target NSSAI.
supplementary note 61. The UE according to supplementary note 60, further comprising:
   means for receiving the Target NSSAI in a case of sending the information indicating the UE supports the Target NSSAI.
supplementary note 62. A communication apparatus comprising:
   means for receiving a message from a User Equipment (UE) during Protocol Data Unit (PDU) session establishment procedure or service request procedure; and
   means for sending Target Network Slice Selection Assistance Information (NSSAI) during the PDU session establishment procedure or the service request procedure.
supplementary note 63. The communication apparatus according to supplementary note 62,
   wherein the Target NSSAI is included in a Non Access Stratum (NAS) message.
supplementary note 64. The communication apparatus according to supplementary note 62 or 63, further comprising:
   means for receiving a Registration Request message,
   wherein the Registration Request message includes Requested NSSAI,
   wherein the Requested NSSAI includes Single Network Slice Selection Assistance Information (S-NSSAI), and
   wherein the S-NSSAI is included in the Target NSSAI.
supplementary note 65. The communication apparatus according to supplementary note 64, further comprising:
   means for performing PDU session modification procedure for the S-NSSAI.
supplementary note 66. The communication apparatus according to any one of supplementary notes 62 to 65, further comprising:
   means for receiving information indicating the UE supports the Target NSSAI.
supplementary note 67. The communication apparatus according to supplementary note 66,
   means for sending the Target NSSAI in a case of receiving the information indicating the UE supports the Target NSSAI.
supplementary note 68. A User Equipment (UE) comprising:
   means for receiving a Radio Resource Control (RRC) message,
   wherein the RRC message includes Target Network Slice Selection Assistance Information (NSSAI); and
   means for sending a Registration Request message,
   wherein the Registration Request message includes Requested NSSAI,
   wherein the Requested NSSAI includes Single Network Slice Selection Assistance Information (S-NSSAI), and
   wherein the S-NSSAI is included in the Target NSSAI.
supplementary note 69. The UE according to supplementary note 68,
   wherein the RRC message is an RRC Release message.
supplementary note 70. The UE according to supplementary note 68 or 69, further comprising:
   means for sending information indicating the UE supports the Target NSSAI.
supplementary note 71. The UE according to supplementary note 70, further comprising:
   means for receiving the Target NSSAI in a case of sending the information indicating the UE supports the Target NSSAI.
supplementary note 72. A communication apparatus comprising:
   means for receiving Target Network Slice Selection Assistance Information (NSSAI); and
   means for sending a Radio Resource Control (RRC) message to a User Equipment (UE),
   wherein the RRC message includes the Target NSSAI.
supplementary note 73. The communication apparatus according to supplementary note 72,
   wherein the RRC message is an RRC Release message.
supplementary note 74. The communication apparatus according to supplementary note 72 or 73, further comprising:
   means for receiving the Target NSSAI in a case where the UE supports the Target NSSAI.
supplementary note 75. A first communication apparatus comprising:
   means for communicating with a second communication apparatus; and
   means for sending Target Network Slice Selection Assistance Information (NSSAI) for a list of a Tracking Area (TA).
supplementary note 76. The first communication apparatus according to supplementary note 75,
   wherein the list of the TA is assigned to a User Equipment (UE).
supplementary note 77. The first communication apparatus according to supplementary note 76,
   wherein the list of the TA includes a first TA where the UE locates and a second TA where the UE does not locate.
supplementary note 78. The first communication apparatus according to any one of supplementary notes 75 to 77, further comprising:
   means for receiving the list of the TA.
supplementary note 79. The first communication apparatus according to supplementary note 78,
   wherein the list of the TA is included in a NG SETUP REQUEST message.
supplementary note 80. The first communication apparatus according to any one of supplementary notes 75 to 79,
   wherein the Target NSSAI is included in a NG SETUP RESPONSE message.
supplementary note 81. The first communication apparatus according to any one of supplementary notes 75 to 79,
   wherein the Target NSSAI is included in an AMF CONFIGURATION UPDATE message.
supplementary note 82. A first communication apparatus comprising:
   means for communicating with a second communication apparatus; and
   means for receiving Target Network Slice Selection Assistance Information (NSSAI) for a list of a Tracking Area (TA).
supplementary note 83. The first communication apparatus according to supplementary note 82,
   wherein the list of the TA is assigned to a User Equipment (UE).
supplementary note 84. The first communication apparatus according to supplementary note 83,
   wherein the list of the TA includes a first TA where the UE locates and a second TA where the UE does not locate.
supplementary note 85. The first communication apparatus according to any one of supplementary notes 82 to 84, further comprising:
   means for sending the list of the TA.
supplementary note 86. The first communication apparatus according to supplementary note 85,
   wherein the list of the TA is included in a NG SETUP REQUEST message.
supplementary note 87. The first communication apparatus according to any one of supplementary notes 82 to 86,
   wherein the Target NSSAI is included in a NG SETUP RESPONSE message.
supplementary note 88. The first communication apparatus according to any one of supplementary notes 82 to 86,
   wherein the Target NSSAI is included in an AMF CONFIGURATION UPDATE message.

This application is based upon and claims the benefit of priority from Indian provisional patent application No. 202211055756, filed on Sep. 28, 2022, the disclosure of which is incorporated herein in its entirety by reference.

### REFERENCE SIGNS LIST

1 telecommunication system
3 UE
31 transceiver circuit
32 antenna
33 controller
34 user interface
35 Universal Subscriber Identity Module (USIM)
36 memory
361 operating system
362 communications control module
3621 transceiver control module
5 (R)AN node
51 transceiver circuit
52 antenna
53 network interface
54 controller
55 memory
551 operating system
552 communications control module
5521 transceiver control module
60 Radio Unit (RU)
601 transceiver circuit
602 antenna
603 network interface
604 controller
605 memory
6051 operating system
6052 communications control module
60521 transceiver control module
61 Distributed Unit (DU)
611 transceiver circuit
612 network interface
613 controller
614 memory
6141 operating system
6142 communications control module
61421 transceiver control module
62 Centralized Unit (CU)
621 transceiver circuit
622 network interface
623 controller
624 memory
6241 operating system
6242 communications control module
62421 transceiver control module
7 core network
70 mobility management function (AMF)
701 transceiver circuit
702 network interface
703 controller
704 memory
7041 operating system
7042 communications control module
70421 transceiver control module
71 Session Management Function (SMF)
72 User Plane Function (UPF)
73 Policy Control Function (PCF)
731 transceiver circuit
732 network interface
733 controller
734 memory
7341 operating system
7342 communications control module
73421 transceiver control module
74 Authentication Server Function (AUSF)
741 transceiver circuit
742 network interface
743 controller
744 memory
7441 operating system
7442 communications control module
74421 transceiver control module
75 Unified Data Management (UDM)
751 transceiver circuit
752 network interface
753 controller
754 memory
7541 operating system
7542 communications control module
75421 transceiver control module
76 Network Slice Selection Function (NSSF)
761 transceiver circuit
762 network interface
763 controller
764 memory
7641 operating system
7642 communications control module
76421 transceiver control module
20 data network
201 AAA

What is claimed is:

1. A method of a first communication apparatus, the method comprising:
communicating with a second communication apparatus; and
sending Target Network Slice Selection Assistance Information (NSSAI) for a list of a Tracking Area (TA).

2. The method according to claim 1,
wherein the list of the TA is assigned to a User Equipment (UE).

3. The method according to claim 2,
wherein the list of the TA includes a first TA where the UE locates and a second TA where the UE does not locate.

4. The method according to claim 1, further comprising:
receiving the list of the TA.

5. The method according to claim 4,
wherein the list of the TA is included in a NG SETUP REQUEST message.

6. The method according to claim 1,
wherein the Target NSSAI is included in a NG SETUP RESPONSE message.

7. The method according to claim 1,
wherein the Target NSSAI is included in an AMF CONFIGURATION UPDATE message.

8. A method of a first communication apparatus, the method comprising:
communicating with a second communication apparatus; and
receiving Target Network Slice Selection Assistance Information (NSSAI) for a list of a Tracking Area (TA).

9. The method according to claim 8,
wherein the list of the TA is assigned to a User Equipment (UE).

10. The method according to claim 9,
wherein the list of the TA includes a first TA where the UE locates and a second TA where the UE does not locate.

11. The method according to claim 8, further comprising:
sending the list of the TA.

12. The method according to claim 11,
wherein the list of the TA is included in a NG SETUP REQUEST message.

13. The method according to claim 8,
wherein the Target NSSAI is included in a NG SETUP RESPONSE message.

14. The method according to claim 8,
wherein the Target NSSAI is included in an AMF CONFIGURATION UPDATE message.

15. A first communication apparatus comprising:
at least one memory; and
at least one hardware processor coupled to the at least one memory,
wherein the at least one hardware processor is configured to
send Target Network Slice Selection Assistance Information (NSSAI) for a list of a Tracking Area (TA).

16. The first communication apparatus according to claim 15,
wherein the list of the TA is assigned to a User Equipment (UE).

17. The first communication apparatus according to claim 16,
wherein the list of the TA includes a first TA where the UE locates and a second TA where the UE does not locate.

18. The first communication apparatus according to claim 15,
wherein the at least one hardware processor is configured to receive the list of the TA.

19. The first communication apparatus according to claim 18,
wherein the list of the TA is included in a NG SETUP REQUEST message.

20. The first communication apparatus according to claim 15,
wherein the Target NSSAI is included in a NG SETUP RESPONSE message or an AMF CONFIGURATION UPDATE message.

21.-28. (canceled)
